(19) United States
(12) Patent Application Publication
(10) Pub. No.: US 2015/0124069 A1
(43) Pub. Date: May 7, 2015

(54) INFORMATION PROCESSING DEVICE AND INFORMATION PROCESSING METHOD

(71) Applicant: SONY CORPORATION, Tokyo (JP)

(72) Inventors: Takeo TSUKAMOTO, Tokyo (JP); Jun KIMURA, Kanagawa (JP)

(21) Appl. No.: 14/525,666

(22) Filed: Oct. 28, 2014

(30) Foreign Application Priority Data
Nov. 6, 2013 (JP) 2013-229922

(51) Int. Cl. G06K 9/00; G02B 27/01; H04N 7/18

(52) U.S. Cl. CPC G06K 9/00604; H04N 7/18; G02B 27/017; G02B 2027/0178
USPC 348/78

(57) ABSTRACT

There is provided an information processing device including a line of sight detection unit configured to detect a direction of a line of sight based on an image of an eyeball captured by an imaging unit, and a user identification unit configured to identify a user based on the image of the eyeball captured by the imaging unit.

### CROSS REFERENCE TO RELATED APPLICATIONS

This application claims the benefit of Japanese Priority Patent Application JP 2013-229922 filed Nov. 6, 2013, the entire contents of which are incorporated herein by reference.

### BACKGROUND

The present disclosure relates to an information processing device and an information processing method.

In recent years, as methods of manipulating computers, various kinds of manipulation methods including a manipulation method using a voice recognition technology, a manipulation method implemented by changing an orientation or an inclination of a device or a manipulation device, and the like have been proposed in addition to manipulation methods using a keyboard and a mouse. Among the manipulation methods, a technology in which a line of sight of a user is used as an input (which may be referred to hereinafter as an “input of a line of sight”) has been proposed as a manipulation method that uses biological information. For example, JP 2009-54101A discloses a technology that relates to an input of a line of sight.

In addition, recently, technologies that use biological information of users when the users are to be recognized (authenticated) have been proposed. As described above, as a technology for recognizing a user using his or her biological information, for example, a technology for recognizing the user using an image of his or her eye (eyeball) such as an iris recognition technology in which a user is recognized based on a pattern of his or her iris has been proposed.

### SUMMARY

Meanwhile, a technology that can realize both of a technology of using a line of sight of a user as an input as described above and a technology of recognizing a user, both of which use information of an eyeball of the user, has been desired. Therefore, the present disclosure proposes a novel and improved information processing device and information processing method that can realize both of a process of detecting a line of sight and a process of identifying a user using information of an eyeball with a simpler configuration.

According to an embodiment of the present disclosure, there is provided an information processing device including a line of sight detection unit configured to detect a direction of a line of sight based on an image of an eyeball captured by an imaging unit, and a user identification unit configured to identify a user based on the image of the eyeball captured by the imaging unit.

According to another embodiment of the present disclosure, there is provided an information processing method including causing a processor to detect a direction of a line of sight based on an image of an eyeball captured by an imaging unit, and causing the processor to identify a user based on the image of the eyeball captured by the imaging unit.

According to the present disclosure as described above, an information processing device and an information processing method that can realize both of a process of detecting a line of sight and a process of identifying a user using information of an eyeball with a simpler configuration is proposed. Note that the effect described above is not limitative at all, and along with the effect or instead of the effect, any effect that is desired to be introduced in the present specification or another effect that can be ascertained from the present specification may be exhibited.

### BRIEF DESCRIPTION OF THE DRAWINGS

FIG. 1 is a diagram showing an example of an external appearance of an information processing device according to a first embodiment of the present disclosure;

FIG. 2 is a diagram showing an example of a hardware configuration of the information processing device according to the embodiment;

FIG. 3 is a block diagram showing an example of a functional configuration of the information processing device according to the embodiment;

FIG. 4 is a diagram for describing an overview of an information processing device according to a second embodiment of the present disclosure;

FIG. 5 is a diagram for describing an operation of the information processing device according to the embodiment;

FIG. 6 is a block diagram showing an example of a functional configuration of the information processing device according to the embodiment;

FIG. 7 is a diagram showing an example of user information according to the embodiment;

FIG. 8 is a flowchart showing an example of the flow of a series of processes of the information processing device according to the embodiment;

FIG. 9 is a diagram for describing an overview of the information processing device according to Example 1;

FIG. 10 is a diagram showing an example of user information according to Example 1;

FIG. 11 is a diagram for describing an example of an input method of information in the information processing device according to Example 1;

FIG. 12 is a diagram for describing an example of an input method of information in the information processing device according to Example 1;

FIG. 13 is a diagram for describing an example of an input method of information in the information processing device according to Example 1;

FIG. 14 is a diagram for describing an overview of an information processing device according to Example 2;

FIG. 15 is a diagram for describing an overview of an information processing device according to Example 3;

FIG. 16 is a diagram for describing an overview of an information processing device according to Example 4;

FIG. 17 is a diagram for describing an overview of an information processing system according to a third embodiment of the present disclosure;

FIG. 18 is a block diagram showing an example of a functional configuration of the information processing system according to the embodiment; and

FIG. 19 is a diagram for describing an example of an information display method of the information processing system according to the embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that description will be provided in the following order.

1. First embodiment
1.1. Overview of an information processing device
1.2. Hardware configuration of the information processing device
1.3. Functional configuration of the information processing device

2. Second embodiment
2.1. Overview of an information processing device
2.2. Functional configuration of the information processing device
2.3. Process flow

3. Examples
3.1. Example 1: Application example to a profile input screen
3.2. Example 2: Application example to a browser
3.3. Example 3: Application example to an activation menu of an application
3.4. Example 4: Application example to user authentication

4. Third embodiment
4.1. Overview of an information processing device
4.2. Functional configuration of the information processing device

5. Conclusion

### 1. First Embodiment

### 1.1. Overview of an Information Processing Device

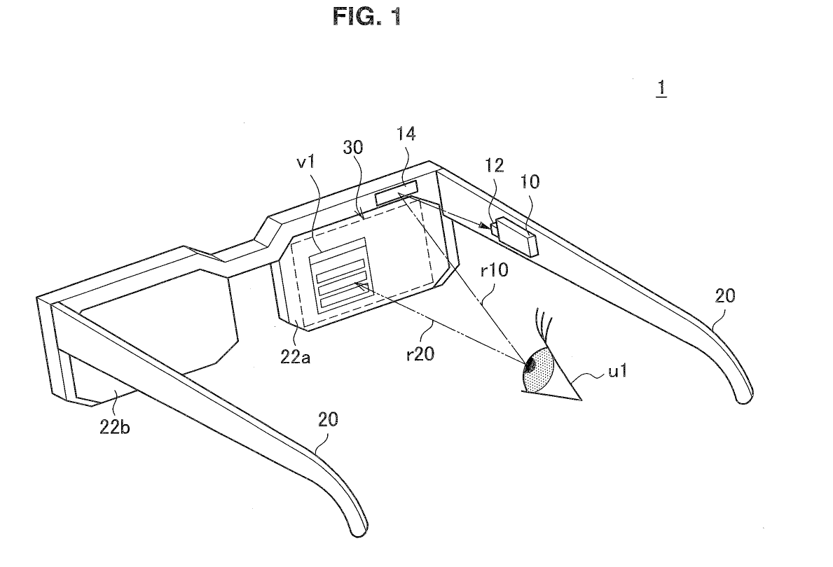

First, a schematic configuration of an information processing device 1 according to a first embodiment of the present disclosure will be described with reference to FIG. 1. FIG. 1 is a diagram showing an example of an external appearance of the information processing device 1 according to the first embodiment of the present disclosure. As shown in FIG. 1, the information processing device 1 can be configured as an eyeglass-type display device (for example, a display) or information processing device configured such that, for example, when a user wears the device on his or her head, a display unit 30 is held in front of the user's eyes (for example, in the vicinity of the front of an eyeball u1).

The information processing device 1 includes, for example, lenses 22a and 22b, holding units 20, the display unit 30, an information processing unit 10, an imaging unit 12, and a mirror 14. In FIG. 1, the lens 22b corresponds to the lens for the left eye held in front of the left eye and the lens 22a corresponds to the lens for the right eye held in front of the right eye. Note that, in the information processing device 1 according to the present embodiment, it is not necessary for the lenses 22a and 22b to have a function of correcting the vision of the user, i.e., a function of diffusing and converging the light through refraction. The holding units 20 correspond to, for example, the frame of eyeglasses, and holds the information processing device 1 on the head of the user so that the lenses 22a and 22b are held in front of the user's eyes.

In addition, the display unit 30 for causing information or content (for example, display information v1) to be displayed thereon may be formed in at least a partial region on at least one of the lenses 22a and 22b. For the display unit 30, for example, a liquid crystal panel is used, and the display unit is configured to be controllable such that the unit is in a through state, i.e., a transparent or a semi-transparent state, by controlling transmittance thereof.

Note that the display unit 30 described above is merely an example, and as long as at least a partial region on at least one of the lenses 22a and 22b can be realized as the display unit 30 for displaying information, a configuration of the display unit is not particularly limited. For example, by providing an image projection device that has a partial region of the lens 22a as a projection face, the partial region may be set as the display unit 30. In addition, it is not necessary to provide both of the lenses 22a and 22b at all times, and only one of the lenses 22a and 22b may be provided and used as the display unit 30. Note that, when only one of the lenses 22a and 22b is provided, it is needless to say that the configuration of the holding units 20 is not limited to the example shown in FIG. 1 and may be arbitrarily modified.

In addition, a control unit for operating at least a partial region on at least one of the lenses 22a and 22b as the display unit 30 may be provided in, for example, the position of either of the holding units 20, or may be realized as the function of a part of the information processing unit 10 to be described later.

In addition, although the example in which at least one of the lenses 22a and 22b on which the display unit 30 is provided is realized as a transmissive-type display has been described above, the configuration of the display unit is not limited to a transmissive-type display as described above. A configuration in which, for example, the entire face of the portion corresponding to the lenses 22a and 22b is set at a display, an imaging unit that captures the direction of a line of sight is separately provided, and an image captured by the imaging unit is displayed on the display corresponding to the lenses 22a and 22b may also be used. Note that it is needless to say that, when at least one of the lenses 22a and 22b on which the display unit 30 is provided is realized as a transmissive-type display, for example, the lenses 22a and 22b are formed of a transparent material such as a resin or glass.

In addition, the information processing device 1 according to the present embodiment captures an image of the eyeball u1 of the user, and performs detection of the starting point of a line of sight of the eyeball u1 and the direction of the line of sight (the starting point and the direction thereof may be collectively referred to hereinafter as a “direction of a line of sight r20”) and identification of the user based on the captured image of the eyeball. To be specific, the imaging unit 12 captures the image of the eyeball u1 and the information processing unit 10 performs the detection of the direction of the line of sight r20 and the identification of the user based on the image of the eyeball u1 captured by the imaging unit 12.

The imaging unit 12 and the information processing unit 10 are held, for example, by a part of the holding unit 20. As a specific example, in the example shown in FIG. 1, the imaging unit 12 and the information processing unit 10 are held by the portion corresponding to a temple (arm) of the eyeglasses. In the case of the configuration shown in FIG. 1, the imaging unit 12 captures an image (a still image or a dynamic image) of the eyeball u1 reflected on the mirror 14 as indicated by an optical path r10, and outputs the captured image of the eyeball u1 to the information processing unit 10. Then, the information processing unit 10 analyzes the image of the eyeball u1 acquired from the imaging unit 12 to perform detection of the direction of the line of sight r20 and identification of the user.

As an example of the method for identifying a user based on an image of the eyeball u1, an iris recognition technology for identifying a user based on a pattern of the iris in the eyeball u1 is exemplified. To be specific, when a user is identified based on iris recognition, the information processing unit 10 identifies a user by extracting the iris positioned in the vicinity of (around) the pupil from an image of the eyeball u1 and comparing the pattern of the extracted iris to a pattern stored in advance.

In addition, the information processing unit 10 extracts the pupil from the image of the eyeball u1, and detects the direction of the line of sight r20 based on the position of the extracted pupil. In other words, the information processing unit 10 can standardize the process relating to extraction of a pupil for detecting the direction of the line of sight r20 and the process relating to extraction of an iris for identifying a user in extraction of the pupil and the iris from an image of the eyeball u1.

Here, there are many cases in which the process relating to the extraction of a pupil and the process relating to the extraction of an iris cause a relatively high processing load in comparison with, for example, other processes in a series of processes performed for iris recognition (as a specific example, processes of extracting the pattern of the iris and relating to comparison of the pattern). For this reason, by standardizing at least the process relating to the extraction of a pupil, the information processing device 1 according to the present embodiment can reduce a processing load in comparison with the case in which each of the processes is individually executed, and further can simplify the configuration of the information processing unit 10. Note that the information processing device 1 may standardize the process relating to the extraction of an iris along with the above process depending on a detection method of the direction of the line of sight r20.

Note that the configuration shown in FIG. 1 is merely an example, and the positions of the imaging unit 12 and the information processing unit 10 are not particularly limited as long as an image of the eyeball u1 can be captured and the captured image of the eyeball u1 can be analyzed. For this reason, it is not absolutely necessary to provide the mirror 14 according to, for example, the position in which the imaging unit 12 is held. In addition, the information processing unit 10 may be provided in an external device separate from the information processing device 1. An example in which the information processing unit 10 is provided in an external device separate from the information processing device 1 will be described separately.

In addition, although the example of iris authentication has been described above as an example of the method for identifying a user, the method is not necessarily limited to iris authentication as long as a user can be identified based on an image of the eyeball u1. For example, the information processing unit 10 may identify a user based on a retina pattern specified from an image of the eyeball u1.

In addition, the configuration of the imaging unit 12 is not particularly limited as long as the detection of the direction of the line of sight r20 and the identification of a user can be performed based on an image of the eyeball u1 captured by the imaging unit 12. For this reason, the configuration of the imaging unit 12 and the content of a process may be arbitrarily modified according to, for example, the processing logic for specifying the direction of the line of sight r20 and the processing logic for identifying a user.

For example, when a user is identified based on iris recognition, an infrared (IR) camera which has good compatibility with the process relating to the detection of the direction of the line of sight r20 can be applied as the imaging unit 12. In this manner, a common imaging unit can be applied to both of the detection of the direction of the line of sight r20 and the identification of a user in the information processing device 1 according to the present embodiment. In addition, when a user is identified based on a retina pattern, the imaging unit 12 may radiate invisible infrared rays with low energy at the time of capturing an image such that blood vessels on the retina can be easily identified.

### 1.2. Hardware Configuration of the Information Processing Device

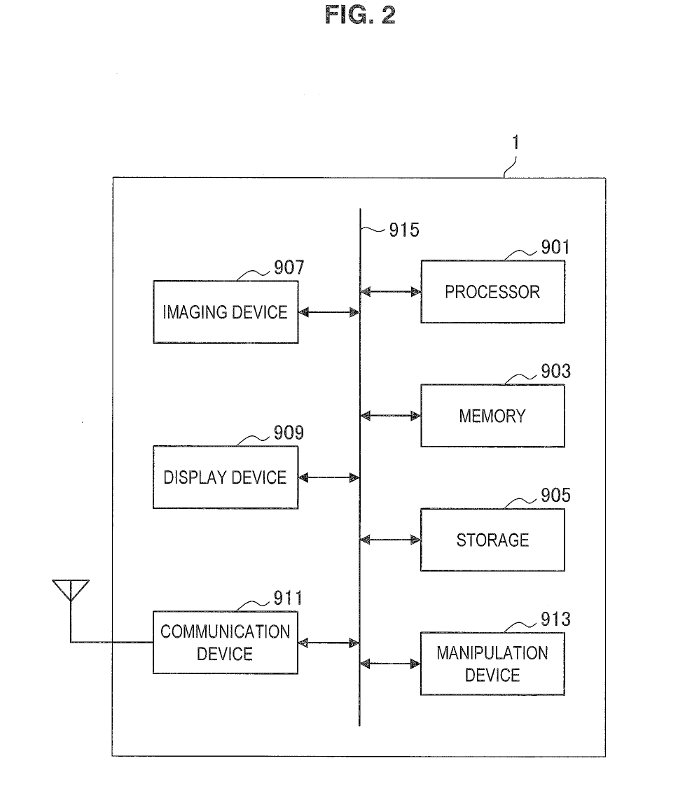

Next, an example of a hardware configuration of the information processing device 1 according to the present embodiment will be described with reference to FIG. 2. FIG. 2 is a diagram showing the example of the hardware configuration of the information processing device according to the present embodiment. As shown in FIG. 2, the information processing device 1 according to the present embodiment includes a processor 901, a memory 903, a storage 905, an imaging device 907, a display device 909, and a bus 915. In addition, the information processing device 1 may include a communication device 911 and a manipulation device 913.

The processor 901 may be, for example, a central processing unit (CPU), a graphical processing unit (GPU), a digital signal processor (DSP), or a system on chip (SoC), which executes various processes of the information processing device 1. The processor 901 can be constituted by, for example, an electronic circuit for executing various arithmetic operation processes. The memory 903 includes a random access memory (RAM) and a read-only memory (ROM), which stores programs executed by the processor 901 and data. The storage 905 can include a storage medium such as a semiconductor memory or a hard disk.

The imaging device 907 has the function of capturing still images or dynamic images through a lens under the control of the processor 901. The imaging device 907 may cause the memory 903 or the storage 905 to store captured images.

The display device 909 is an example of an output device, which may be a display device such as a liquid crystal display (LCD) device, or an organic light emitting diode (OLED) display device. The display device 909 can provide information to user by displaying a screen. Note that, when the information processing device 1 is configured as an eyeglass-type display device as shown in FIG. 1, a transmissive-type display may be applied thereto as the display device 909.

The communication device 911 is a communication section of the information processing device 1, and communicates with an external device via a network. The communication device 911 is an interface for wireless communication, and may include a communication antenna, a radio frequency (RF) circuit, a baseband processor, and the like. The communication device 911 has the function of performing various kinds of signal processing on signals received from external devices, and can supply digital signals generated from received analog signals to the processor 901.

The manipulation device 913 has the function of generating input signals when a user performs a desired manipulation. The manipulation device 913 may be constituted by, for example, an input unit such as a button and a switch used by the user to input information, an input control circuit that generates input signals based on inputs made by the user and then supplies the signals to the processor 901.

The bus 915 causes the processor 901, the memory 903, the storage 905, the imaging device 907, the display device 909, the communication device 911, and the manipulation device 913 to be connected to one another. The bus 915 may include a plurality of kinds of buses.

### 1.3. Functional Configuration of the Information Processing Device

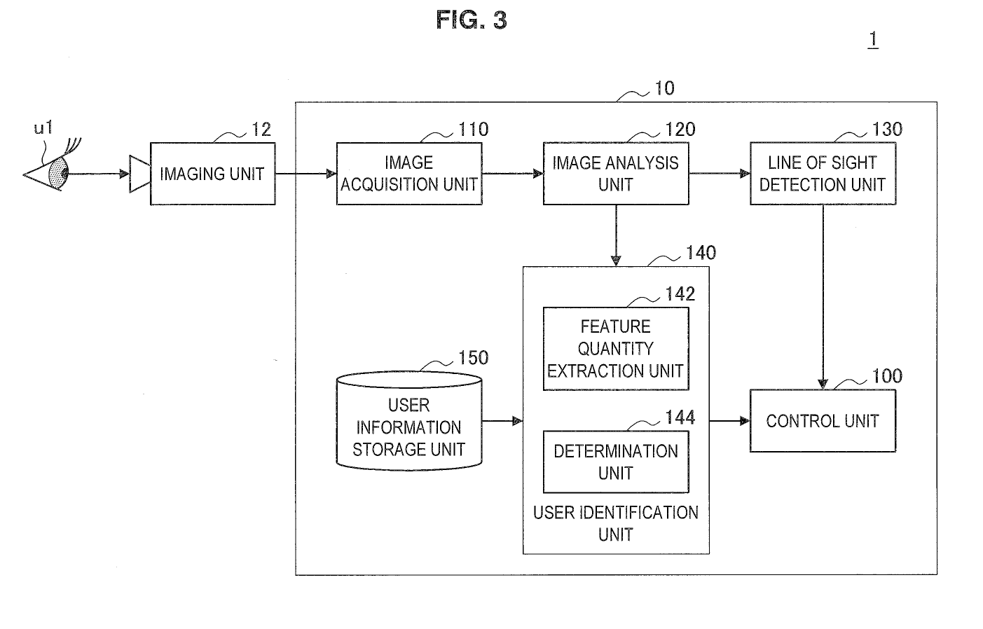

Next, a functional configuration of the information processing device 1 according to the present embodiment will be described with reference to FIG. 3, particularly focusing on a configuration of the information processing unit 10. FIG. 3 is a block diagram showing an example of the functional configuration of the information processing device according to the present embodiment. The example shown in FIG. 3 shows the information processing device 1 shown in FIG. 1, focusing only on the configuration thereof in which an image of the eyeball u1 is captured and the detection of the direction of the line of sight r20 and the identification of a user are performed based on the captured image of the eyeball u1. Note that an example of the configuration of the information processing device 1 shown in FIG. 1 in which information is displayed on the display unit 30 will be described later separately as a second embodiment.

As shown in FIG. 3, the information processing unit 10 includes an image acquisition unit 110, an image analysis unit 120, a line of sight detection unit 130, a user identification unit 140, a user information storage unit 150, and a control unit 100.

(Image Acquisition Unit 110)

The image acquisition unit 110 acquires an image of the eyeball u1 captured by the imaging unit 12 from the imaging unit 12. The image acquisition unit 110 supplies the captured image to the image analysis unit 120. Note that a timing at which the image acquisition unit 110 acquires the image of the eyeball u1 (in other words, a timing at which the imaging unit 12 captures the image of the eyeball u1) is decided in advance according to a timing at which the direction of the line of sight r20 is detected and a timing at which a user is identified.

As a specific example, when the detection of the direction of the line of sight r20 is performed in real time, the image acquisition unit 110 may sequentially acquire images of the eyeball u1 captured by the imaging unit 12 at each predetermined timing (for example, at each interval of detection of the direction of the line of sight r20). In addition, the image acquisition unit 110 may be set such that the start and end of the detection of the direction of the line of sight r20 can be controlled based on a user manipulation.

In addition, as another example, when a predetermined process is executed, the image acquisition unit 110 may acquire the image of the eyeball u1 captured by the imaging unit 12 in connection with the execution of the process. As a specific example, when the information processing device 1 is activated or a user wears the information processing device 1 on his or her head, the image acquisition unit 110 may acquire an image of the eyeball u1 for identifying a user in connection with such a relevant process.

Note that the above description merely shows the example of a timing at which the image acquisition unit 110 acquires an image of the eyeball u1, and does not limit application of the acquired image. For example, an image acquired at a certain timing may be used in detection of the direction of the line of sight r20 or may be used in identification of a user. In addition, any of images sequentially acquired at each predetermined timing may be used in identification of a user. In addition, it is needless to say that the imaging unit 12 acquires an image according to (for example, in synchronization with) timings at which the image acquisition unit 110 acquires the image.

(Image analysis unit 120)

The image analysis unit 120 acquires the image of the eyeball u1 captured by the imaging unit 12 from the image acquisition unit 110. The image analysis unit 120 extracts information necessary for the detection of the direction of the line of sight r20 and the identification of a user from the image by performing an analysis process on the acquired image. When the iris recognition technology is used as a method for identifying a user, for example, the image analysis unit 120 extracts a region representing the pupil and the iris (the region representing the pupil and the iris may be referred to hereinafter simply as a “pupil and iris region”) from the acquired image of the eyeball u1. Note that the configuration of the image analysis unit 120 which relates to detection of a pupil corresponds to an example of a “pupil detection unit.”

In this case, the image analysis unit 120 may extract, for example, a region formed with pixels indicating a pixel value representing a pupil and an iris from the acquired image as the pupil and iris region. For example, pixel values of pixels indicating the white of an eye are positioned on a white side (a side with high brightness) and pixel values of pixels indicating the pupil and the iris are positioned on a darker side (a side with low brightness) in comparison with the pixels indicating the white of the eye. For this reason, the image analysis unit 120 may extract the pupil and iris region by comparing, for example, the pixel values of each pixel to a threshold value. Note that the “white of an eye” in the present description is assumed to indicate the region of the eyeball exposed to the outside when the eyelid is open other than the pupil and the iris, i.e., the sclera.

In addition, as another example, pixel values radically change in between the region indicating the white of the eye and the region indicating the pupil and the iris. For this reason, the image analysis unit 120 may recognize, for example, a portion of which a change amount of pixel values is equal to or higher than the threshold value as the boundary of the region indicating the white of the eye and the region indicating the pupil and the iris, and extract the region surrounded by the boundary as the region indicating the pupil and the iris.

In addition, it is needless to say that the image analysis unit 120 may extract a region indicating the pupil and a region indicating the iris as separate regions. In this case, the image analysis unit 120 may identify and extract the region indicating the pupil and the region indicating the iris using, for example, the difference between the pixel values of pixels representing the pupil and the pixel values of pixels representing the iris.

Note that the above is an example of an operation of the image analysis unit 120 when a user is identified based on the iris recognition technology, and it is needless to say that, when a user is identified using another technology, the content of the operation of the image analysis unit 120 may be appropriately modified. For example, when a user is identified based on a retina pattern, the image analysis unit 120 may extract the region of the pupil used for detecting the direction of the line of sight r20 and the region of blood vessels on the retina used for identifying a user.

In addition, in order to improve accuracy for extracting information necessary for detection of the direction of the line of sight r20 and identification of a user (for example, detection accuracy), the image analysis unit 120 may perform a process relating to adjustment of brightness and contrast on the acquired image of the eyeball u1. Note that, hereinbelow, operations of each constituent element of the information processing unit 10 for identifying a user using the iris recognition technology will be described. The image analysis unit 120 outputs the extracted information indicating the position and size of the pupil and iris region (the information may be referred to hereinafter as “information indicating the pupil and iris region”) and the acquired image of the eyeball u1 to the line of sight detection unit 130 and the user identification unit 140 respectively.

(Line of sight detection unit 130)

The line of sight detection unit 130 acquires the image of the eyeball u1 and the information indicating the pupil and iris region from the image analysis unit 120. The line of sight detection unit 130 specifies the position of the pupil in the image of the eyeball u1 based on the acquired information indicating the pupil and iris region, and then detects the direction of the line of sight r20 based on the specified position of the pupil.

For example, the line of sight detection unit 130 may detect the direction of the line of sight r20 based on the position of the pupil region in the acquired image. In this case, the line of sight detection unit 130 may specify, for example, the position of the pupil region as the starting point of the line of sight of the eyeball u1. In addition, using the position of the pupil region when the direction of the line of sight r20 faces the front as a reference position, the line of sight detection unit 130 specifies a direction in which the line of sight faces based on a position of the pupil region with respect to the reference position and the distance between the reference position and the pupil region. The line of sight detection unit 130 may specify (detect) the direction of the line of sight r20 based on the starting point of the line of sight and the direction in which the line of sight faces.

Note that the extent to which the direction of the line of sight r20 changes according to the reference position and the positional relation between the reference position and the pupil region may be investigated in advance through, for example, an experiment or the like and then the investigated information may be stored in a region from which the line of sight detection unit 130 can read data. In addition, as another example, a mode in which a change amount of the direction of the line of sight r20 according to the reference position and the positional relation between the reference position and the pupil region (for example, a mode for performing calibration) may be provided so that the line of sight detection unit 130 may acquire information indicting the reference position and the change amount of the direction of the line of sight r20 in the mode.

In addition, as another example, the line of sight detection unit 130 may detect the direction of the line of sight r20 based on a relative position of the pupil region to the region indicating the white of the eye. For example, the line of sight detection unit 130 may specify a direction in which the line of sight faces based on the direction and the degree in which the pupil region is biased with respect to the region indicating the white of the eye. In addition, the line of sight detection unit 130 may specify a position in the pupil region as the starting point of the line of sight of the eyeball u1 in the same manner as the above-described method. Then, based on the specified starting point of the line of sight and direction in which the line of sight faces as described above, the line of sight detection unit 130 may specify (detect) the direction of the line of sight r20. Note that it is needless to say that, when only the pupil region out of the pupil and iris region is used in detecting the direction of the line of sight r20, the line of sight detection unit 130 may be configured to acquire the image of the eyeball u1 and the pupil region from the image analysis unit 120.

The line of sight detection unit 130 outputs information indicating the detected direction of the line of sight r20 (for example, information indicating the starting point of the line of sight and information indicating the direction of the line of sight) to the control unit 100.

(User Identification Unit 140)

The user identification unit 140 is a constituent element for identifying a user based on the image of the eyeball u1 captured by the imaging unit 12. Herein, a case in which the user identification unit 140 identifies a user with an input of the image of the eyeball u1 based on the iris recognition technology will be described as an example.

As shown in FIG. 3, the user identification unit 140 includes a feature quantity extraction unit 142 and a determination unit 144. The user identification unit 140 acquires the image of the eyeball u1 and the information indicating the pupil and iris region from the image analysis unit 120. The user identification unit 140 outputs the acquired image of the eyeball u1 and information indicating the pupil and iris region to the feature quantity extraction unit 142 and then instructs the feature quantity extraction unit 142 to extract the feature quantity of the iris pattern based on the image of the eyeball u1.

(Feature Quantity Extraction Unit 142)

The feature quantity extraction unit 142 acquires the image of the eyeball u1 and the information indicating the pupil and iris region from the user identification unit 140, and receives the instruction relating to extraction of the feature quantity of the iris pattern from the user identification unit 140. The feature quantity extraction unit 142 extracts the region that corresponds to the iris from the image of the eyeball u1 based on the information indicating the pupil and iris region and then detects the iris pattern from the extracted region. Then, the feature quantity extraction unit 142 extracts the feature quantity of the iris pattern (for example, the feature quantity based on feature points of the iris pattern) necessary for performing iris recognition from the detected iris pattern. The feature quantity extraction unit 142 outputs information indicating the feature quantity of the iris pattern extracted from the image of the eyeball u1 to the determination unit 144.

(Determination Unit 144)

The determination unit 144 acquires the information indicating the feature quantity of the iris pattern extracted from the image of the eyeball u1 from the feature quantity extraction unit 142. The determination unit 144 compares the acquired feature quantity of the iris pattern to feature quantities of iris patterns acquired from users in advance to identify a user who corresponds to the acquired feature quantity of the iris pattern. Note that the information indicating the feature quantities of the iris patterns acquired from the users in advance may be stored in, for example, the user information storage unit 150. The user information storage unit 150 stores information of each user in advance in association with identification information for identifying the user.

For example, the user information storage unit 150 may store information indicating the feature quantity of the iris pattern acquired from each user in advance in association with the identification information for identifying the user. In the case of the above configuration, the determination unit 144 may specify information indicating a feature quantity of an iris pattern that coincides with the acquired feature quantity of the iris pattern from the user information storage unit 150 and then specify the user based on identification information associated with the specified information.

Note that the user information storage unit 150 may be set to be capable of storing new information. As a specific example, a mode in which information indicating a feature quantity of an iris pattern is registered may be provided so that the user information storage unit 150 stores the information indicating the feature quantity of the iris pattern acquired in the mode in association with identification information indicating a user who is designated in the mode. The determination unit 144 outputs information indicating the identified user (for example, identification information for identifying the user) to the control unit 100.

Note that a timing at which the user identification unit 140 identifies a user or acquires information for identifying the user (i.e., the image of the eyeball u1 and information indicating the pupil and iris region) is not particularly limited as long as the timing is before the control unit 100 to be described later uses an identification result of the user. For example, the user identification unit 140 may execute a process relating to identification of a user based on an instruction of the user via a manipulation unit (not illustrated) such as a button. In addition, as another example, the user identification unit 140 may execute the process relating to identification of a user by linking in advance to a predetermined associated process performed when the information processing device 1 is activated or when the user wears the information processing device 1 on his or her head.

In addition, the user identification unit 140 may acquire the image of the eyeball u1 and the information indicating the pupil and iris region from the image analysis unit 120 when the process relating to identification of a user is executed. In addition, as another example, when the user identification unit 140 sequentially acquires the images of the eyeball u1 and the information indicating the pupil and iris region from the image analysis unit 120 and then executes the process for identifying a user, the user identification unit may use the latest image and information among the sequentially acquired images and information.

(Control Unit 100)

The control unit 100 acquires information indicating the user who has been identified based on the images of the eyeball u1 captured by the imaging unit 12 from the determination unit 144 of the user identification unit 140. In addition, the control unit 100 acquires information indicating the detected direction of the line of sight r20 from the line of sight detection unit 130. The control unit 100 controls operations of each constituent elements of the information processing device 1 based on the acquired information indicating the user and information indicating the direction of the line of sight r20.

For example, the control unit 100 may read and reflect a setting of the user (for example, a setting of a user interface (UI)) based on the acquired information indicating the user, and may thereby execute various kinds of control using the detected direction of the line of sight r20 as a user input based on the reflected setting. As a specific example, the control unit 100 may switch information displayed on the display unit 30 shown in FIG. 1 based on the setting of the user that has been read based on the acquired information indicating the user. Note that, in such a case, the user information storage unit 150 may be, for example, caused to store information relating to a setting of each user.

In addition, as another example, the control unit 100 may execute a process relating to determination (for example, authentication) for controlling operations of each constituent element of the information processing device 1 using information associated with an identified user and a user input based on the detected direction of the line of sight r20 as input information. Note that an example of a specific operation of the control unit 100 will be described later in “2. Second embodiment” along with application examples (examples) of the information processing device 1 according to the present embodiment.

Hereinabove, the functional configuration of the information processing device 1 has been described. Note that the imaging unit 12, the display unit 30 and the user information storage unit 150 described above can be respectively realized by the imaging device 907, the display device 909, and the storage 905 shown in FIG. 2. In addition, the image acquisition unit 110, the image analysis unit 120, the line of sight detection unit 130, the user identification unit 140, and the control unit 100 included in the information processing unit 10 can be realized by, for example, the processor 901 shown in FIG. 2. In other words, a program that causes a computer to function as the image acquisition unit 110, the image analysis unit 120, the line of sight detection unit 130, the user identification unit 140, and the control unit 100 can be retained in the storage 905 or the memory 903, and the processor 901 can execute the program.

Note that the positions of each of the constituent elements shown in FIG. 3 are not particularly limited as long as the operation of the information processing device 1 described above is realized. As a specific example, the imaging unit 12 and the information processing unit 10 may each be provided in different information processing devices that are connected to each other via a wireless or wired network. In this case, the imaging unit 12 may be provided in one information processing device configured as an eyeglass-type display device and the information processing unit 10 may be provided in the other information processing device (for example, an information processing terminal such as a smartphone) capable of communicating with the information processing device. It is of course needless to say that the imaging unit 12 may be provided as an externally attached unit.

As described above, the information processing device 1 according to the present embodiment analyzes an image of the eyeball u1 captured by the imaging unit 12 and then performs detection of the direction of the line of sight r20 and identification of a user based on a result of the analysis. In this manner, in the information processing device 1 according to the present embodiment, for the image used to perform the detection of the direction of the line of sight r20 and the identification of a user, the shared imaging unit 12 (for example, an infrared camera) can be used.

In addition, in the information processing device 1 according to the present embodiment, a process relating to analysis of the image is standardized for each of the detection of the direction of the line of sight r20 and the identification of a user. For this reason, the information processing device 1 according to the present embodiment can reduce a processing load in comparison with the case in which the detection of the direction of the line of sight r20 and the identification of a user are separately executed. With the configuration described above, the information processing device 1 according to the present embodiment can realize both of the detection of the direction of the line of sight r20 and the identification of a user with a simpler configuration.

Note that, although the example in which the information processing device 1 is configured as an eyeglass-type display device has been described above, the configuration of the information processing device 1 is not particularly limited as long as identification of a user and detection of the direction of the line of sight r20 are performed based on the image of the eyeball u1 captured by the imaging unit 12. For example, without being limited to the eyeglass-type display device, the information processing device may be realized as a head-mounted-type display device (i.e., a head mount display (HMD)) realized with another configuration. In addition, in such a case, it is not necessary to apply a transmissive-type display to the portion in which the display unit 30 is formed. In addition, when a transmissive-type display is not applied, it is not necessary for the display device to be operated such that a user can visually recognize an image that is shielded by the display unit 30 (in other words, an image that the user can visually recognize when he or she does not wear the display device) (for example, operated such that an image in the direction of the line of sight is captured and the captured image is displayed). In addition, as another example, a terminal may be configured such that the imaging unit 12 is provided in the terminal such as a personal computer (PC) or a smartphone and the terminal performs identification of a user and detection of the direction of the line of sight r20 based on an image of the eyeball u1 captured by the imaging unit 12.

### 2. Second Embodiment

### 2.1. Overview of an Information Processing Device

Next, as a second embodiment of the present disclosure, an example in which the information processing device 1 according to an embodiment of the present disclosure is applied to input support when information is input to an input field displayed on a screen will be described. Note that the information processing device 1 according to the present embodiment may be denoted as an “information processing device 1 a” hereinafter. In addition, the device may be simply denoted as the “information processing device 1” when the information processing device 1 according to the first embodiment described above is not particularly distinguished from the information processing device 1a according to the present embodiment.

First, a task of the information processing device 1a according to the present embodiment will be outlined. As a method for manipulating a terminal such as a PC or a smartphone, input methods using technologies relating to voice recognition and input of a line of sight have been applied in addition to general input methods using a keyboard, a mouse, or a touch panel. Particularly, since input means are limited in a head-mounted-type computer represented by an HMD, there are many cases in which the input methods using the technology relating to voice recognition and input of a line of sight are applied.

As described above, as an example of the input methods using input of a line of sight, a method in which information is input by manipulating a virtual keyboard displayed on a screen through movement of the line of sight or blinking is exemplified. However, a manipulation of inputting text while selecting letters and symbols on the virtual keyboard displayed on the screen by moving the line of sight requires a longer period of time for inputting information in comparison with other input methods (for example, input by voice) and a large amount of movement of the line of sight, and thus a heavy burden is imposed on the eyes.

On the other hand, there are cases in which an input method using voice recognition (which may be referred to hereinafter as “voice input”) is used instead of the input of a line of sight. The voice input, however, is not necessarily appropriate for use in all cases. For example, mobile-type terminals such as smartphones are mostly used in public places. When a terminal is used in a public place in this way and information of high confidentiality such as the password for log-in and the security code of a credit card is to be input, voice input is not appropriate as an information input method. Thus, in a circumstance in which input of a line of sight is used as an information input method, the information processing device 1a according to the present embodiment aims to shorten the time taken for input of information and reduce a burden imposed on a user by input of the information by supporting input of the information.

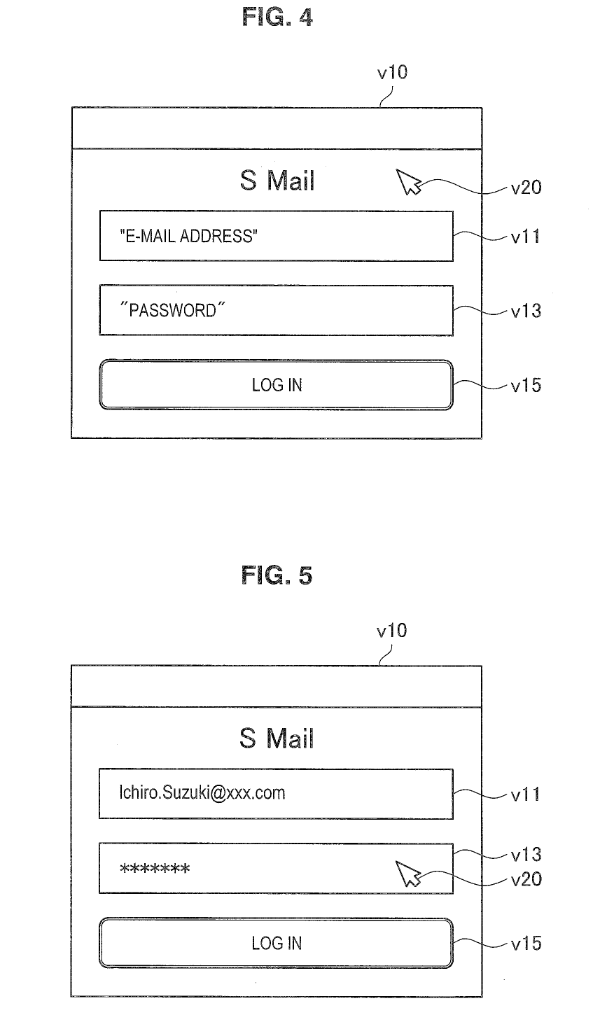

Here, FIG. 4 will be referred to. FIG. 4 is a diagram for describing an overview of the information processing device 1a according to a second embodiment of the present disclosure, showing an example of an input screen when the information processing device 1a is applied to input support and information is input into an input field of the input screen. Hereinbelow, the overview of the information processing device 1a according to the present embodiment will be described exemplifying a case in which information is input to the input screen v10 shown in FIG. 4. The information processing device 1a according to the present embodiment inputs information to the input screen v10 by, for example, causing the display unit 30 to display the input screen v10 as shown in FIG. 1 and using a line of sight of the eyeball u1 as a user input.

FIG. 4 shows an example of the input screen v10 which is an authentication screen shown at the time of using an application such as e-mail software. As shown in FIG. 4, the input screen v10 includes an account input field v11, a password input field v13, and a log-in button v15. The account input field v11 is an input field into which information for the application to identify a user is input. Note that, in the example shown in FIG. 4, an e-mail address of a user is used as the account for identifying the user. In addition, the password input field v13 is an input field into which a password for authenticating the user based on the account which has been input into the account input field v11 is input. In addition, the log-in button v15 is an interface (for example, a button) for requesting authentication based on the information input into the account input field v11 and the password input field v13.

In addition, reference numeral v20 represents a pointer for designating a position on the screen. The information processing device 1a according to the present embodiment detects the direction of a line of sight r20 based on an image of the eyeball u1 captured by the imaging unit 12 and controls operations (display positions) of the pointer v20 based on the detected direction of the line of sight r20. In other words, in the information processing device 1a according to the present embodiment, by manipulating the pointer v20 through movements of the line of sight, a user can input information into the account input field v11 and the password input field v13 of the input screen v10 or manipulate the log-in button v15.

In addition, the information processing device 1a according to the present embodiment performs input support by storing user information such as an e-mail address and the password of the user in association with identification information for identifying the user, and using the user information in information input into each input field.

Specifically, the information processing device 1a identifies the user based on the image of the eyeball u1 captured by the imaging unit 12, and then extracts the user information such as the e-mail address and the password of the identified user. Then, when an input field such as the account input field v11 or the password input field v13 into which information is to be input is selected based on input of the line of sight, the information processing device 1a inputs the extracted user information into the input field.

Here, FIG. 5 will be referred to. FIG. 5 is a diagram for describing an operation of the information processing device 1a according to the present embodiment, showing an example in which information has been input into the account input field v11 and the password input field v13 of the input screen v10 shown in FIG. 4. For example, the information processing device 1a is assumed to have selected the account input field v11 into which an e-mail address is to be input as an account through the input of the line of sight (in other words, through the pointer v20 manipulated through the input of the line of sight). In this case, the information processing device 1a inputs information that corresponds to the e-mail address out of user information extracted based on, for example, an identification result of the user into the selected account input field v11.

In the same manner, when the password input field v13 into which the password is to be input is selected, the information processing device 1a inputs information that corresponds to the password out of the user information extracted based on, for example, the identification result of the user into the selected password input field v13.

As described above, the information processing device 1a identifies a user based on an image of the eyeball u1, and extracts user information of the identified user. Then, when an input field displayed on the screen is selected based on the input of the line of sight, the information processing device 1a inputs the user information of the identified user into the selected input field. With such a configuration, in the information processing device 1a according to the present embodiment, a user can quickly input user information relating to himself or herself into an input field displayed on the screen without performing a complicated manipulation such as manipulating a virtual keyboard through input of a line of sight.

### 2.2. Functional Configuration of the Information Processing Device

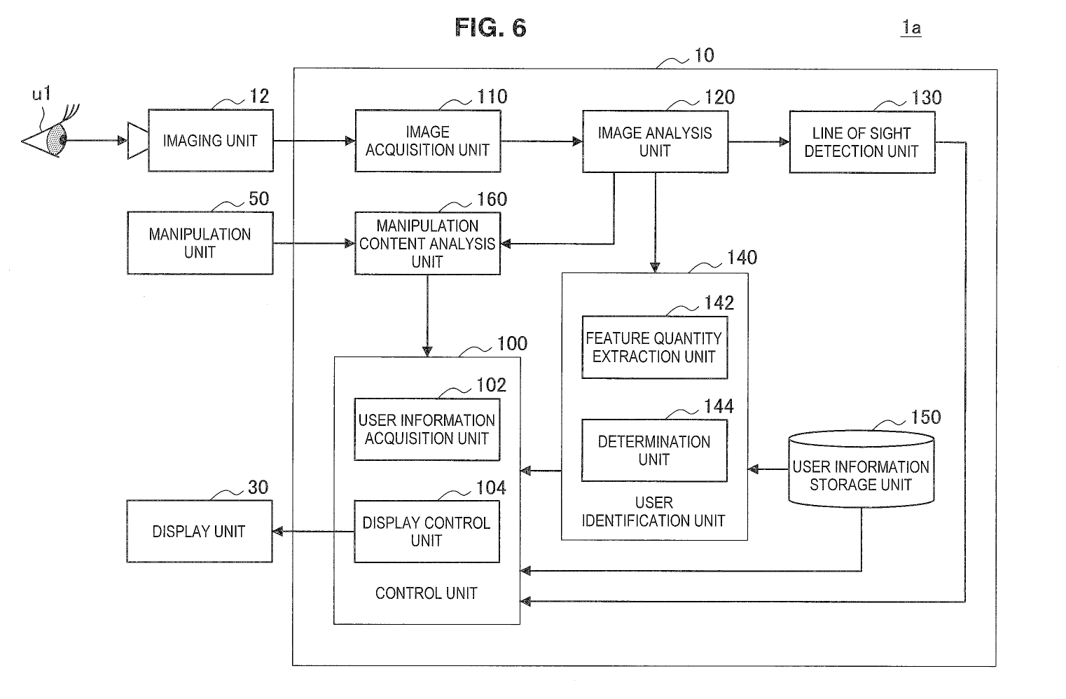

Next, a functional configuration of the information processing device 1a according to the present embodiment will be described with reference to FIG. 6, particularly focusing on a configuration of the information processing unit 10. FIG. 6 is a block diagram showing an example of the functional configuration of the information processing device 1a according to the present embodiment. Note that, hereinbelow, the functional configuration of the information processing device 1a according to the present embodiment will be described focusing on differences with that of the information processing device 1 according to the first embodiment shown in FIG. 3, and detailed description of the same configuration as that of the information processing device 1 according to the first embodiment will not be provided.

(User Information Storage Unit 150)

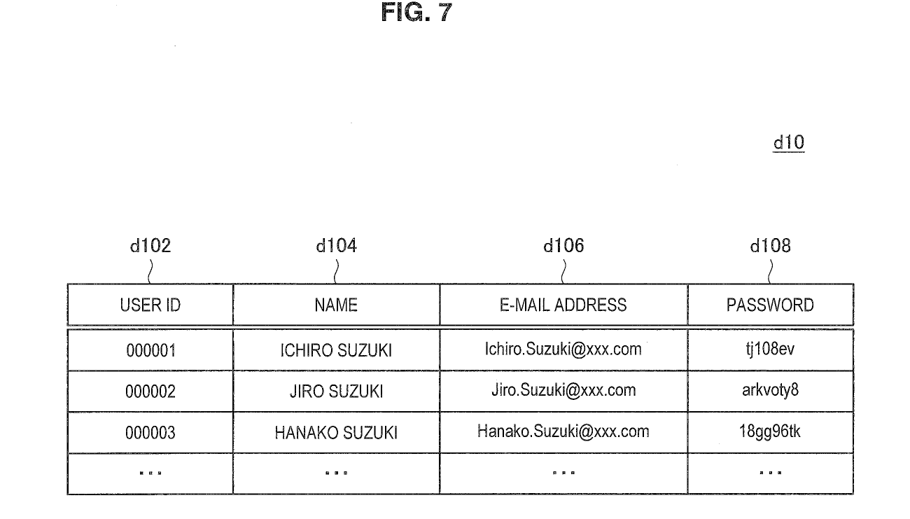

The user information storage unit 150 stores user information of each user associated with the user. For example, FIG. 7 is a diagram showing an example of user information d10 according to the present embodiment. As shown in FIG. 7, the user information d10 includes, for example, a user ID d102, a name d104, an e-mail address d106, and a password d108.

The user ID d102 is an example of identification information for identifying a user (i.e., information indicating a user). In addition, the name d104 shows the name of the user indicated by the user ID d102. In the same manner, the e-mail address d106 shows the e-mail address of the user indicated by the user ID d102. In addition, the password d108 shows the password used by the user indicated by the user ID d102 in authentication.

For example, the user ID d102 may be associated with information used for identifying a user indicated by the user ID d102 such as information indicating a feature quantity of the iris pattern of the user indicated by the user ID d102. With the configuration, the determination unit 144 of the user identification unit 140 can specify the user ID d102 as information indicating the user based on the acquired information indicating the feature quantity of the iris pattern. Then, based on the user ID d102 specified by the determination unit 144, the control unit 100 can extract other user information (which includes the name d104, the e-mail address d106, and the password d108) associated with the user ID d102 in the user information d10 from the user information storage unit 150. Note that, hereinbelow, the user information d10 is assumed to refer to the user information d10 stored in the user information storage unit 150 unless particularly specified otherwise.

(Control Unit 100)

The control unit 100 according to the present embodiment includes a user information acquisition unit 102 and a display control unit 104. When information indicating a user is acquired from the user identification unit 140, the control unit 100 supplies the acquired information indicating the user (user ID d102) to the user information acquisition unit 102. In addition, when information indicating a detected direction of a line of sight r20 is acquired from the line of sight detection unit 130, the control unit 100 supplies the acquired information indicating the direction of the line of sight r20 to the display control unit 104.

(User Information Acquisition Unit 102)

The user information acquisition unit 102 acquires information indicating a user (the user ID d102) from the control unit 100. The user information acquisition unit 102 searches the user information d10 using the acquired information indicating a user as a search key, and thereby extracts other pieces of user information (for example, the name d104, the e-mail address d106, and the password d108) associated with the search key (i.e., the user ID d102). The user information acquisition unit 102 outputs the other pieces of user information extracted from the user information d10 based on the information indicating a user to the display control unit 104.

(Display Control Unit 104)

The display control unit 104 causes the input screen v10 to be displayed on the display unit 30. In addition, using the detected direction of the line of sight r20 as a user input, the display control unit 104 controls (updates) display information (for example, the input screen v10) displayed on the display unit 30 based on the user input. Hereinbelow, the content of an operation of the display control unit 104 will be described in detail. When a predetermined application is activated, the display control unit 104 acquires control information for causing the input screen v10 which is associated with the application to be displayed, and then causes the input screen v10 to be displayed on the display unit 30 based on the acquired control information. Note that the control information for causing the input screen v10 to be displayed may be stored as, for example, part of data for causing the application to be activated in advance in a position from which the display control unit 104 can read the information.

In addition, when identification of a user has been performed by the user identification unit 140, the display control unit 104 acquires user information associated with the identified user from the user information acquisition unit 102.

In addition, the display control unit 104 acquires information indicating the direction of the line of sight r20 detected by the line of sight detection unit 130 from the control unit 100. The display control unit 104 causes the pointer v20 to be displayed in a position which is indicated by the acquired direction of the line of sight r20 on the screen displayed on the display unit 30. Specifically, the display control unit 104 specifies the position at which the line of sight intersects the screen displayed on the display unit 30 based on the relative positional relation between the starting point of the line of sight of the eyeball u1 indicated by the direction of the line of sight r20 and the direction of the line of sight, and the display unit 30. Then, the display control unit 104 causes the pointer v20 to be displayed at the specified position on the screen.

Note that the display control unit 104 may estimate a relative position of the eyeball u1 with respect to the display unit 30 based on the relative positional relation between the holding units 20 and the display unit 30 (i.e., the lens 22a) constituting the information processing device 1 shown in FIG. 1. By presuming the relative position of the eyeball u1 with respect to the display unit 30 in that manner, the display control unit 104 can specify a relative position of the starting point of the line of sight with respect to the display unit 30 based on the estimated position of the eyeball u1. Then, the display control unit 104 can specify the position at which the line of sight intersects the screen displayed on the display unit 30 based on the relative position of the starting point of the line of sight with respect to the display unit 30 and the direction of the line of sight indicated by the direction of the line of sight r20.

In addition, as another example, the display control unit 104 may estimate a relative position of the eyeball u1 with respect to the display unit 30 based on the relative positional relation between the holding units 20, the display unit 30, and the imaging unit 12 and an image of the eyeball u1 captured by the imaging unit 12. Note that the above-described example is merely an example, and the method is not particularly limited as long as the display control unit 104 can specify the position at which the line of sight of the eyeball u1 intersects the screen displayed on the display unit 30 based on the direction of the line of sight r20. By operating as described above, the display control unit 104 specifies a position indicated by the line of sight of the eyeball u1 on the screen displayed on the display unit 30 based on the acquired direction of the line of sight r20.

In addition, when a predetermined manipulation is performed in the state in which the line of sight of the eyeball u1 indicates an input field on the input screen v10 (for example, the account input field v11 or the password input field v13 shown in FIGS. 4 and 5), the display control unit 104 recognizes that the input field has been selected. Here, the predetermined manipulation related to selection of an input field includes, for example, a case where the user has been gazed at the input field longer than the predetermined period of time. Specifically, the display control unit 104 recognizes that the input field has been selected if the position indicated by the line of sight (in other word, the pointer v20) is located within the region indicating the input field longer than the predetermined period of time.

In addition, as another example, when the display control unit 104 receives an instruction from the user to select an input field in the state in which the position indicated by the line of sight is located within the region indicating the input field, the display control unit may recognize that the input field has been selected.

Note that, as a method of recognizing the instruction from the user to select the input field, for example, there is a method of recognizing that the instruction has been given by detecting a specific operation of the user such as blinking of the user. In addition, as another example, when the user operates a manipulation unit 50 such as a predetermined button, there is a method of recognizing the manipulation as an instruction from the user. Note that details of the operation of detecting an instruction of selecting an input field from the user will be described later separately as an operation of a manipulation content analysis unit 160.

When an input field of the input screen v10 is selected, the display control unit 104 inputs the user information acquired by the user information acquisition unit 102 into the selected input field (in other words, causes the user information to be displayed). At this time, when the type of information that can be input into the selected input field is known, the display control unit 104 may input the information that can be input into the selected input field of the acquired user information into the input field.

For example, in the example of the input screen v10 shown in FIG. 4, the type of information corresponding to the e-mail address d106 of the user information d10 shown in FIG. 7 may be associated in advance with the account input field v11 into which an e-mail address is input. Accordingly, when the account input field v11 is selected, the display control unit 104 can specify the e-mail address d106 of the acquired user information which has been associated with the account input field v11 as information to be input into the account input field v11.

The same operation applies to the password input field v13 shown in FIG. 4. In other words, the type of information corresponding to the password d108 of the user information d10 shown in FIG. 7 may be associated in advance with the password input field v13. Accordingly, when the password input field v13 is selected, the display control unit 104 can specify the password d108 of the acquired user information which has been associated with the password input field v13 as information to be input into the password input field v13.

(Manipulation Content Analysis Unit 160)

The manipulation content analysis unit 160 is configured to detect an instruction from a user which relates to selection of an input field of the input screen v10 displayed on the screen of the display unit 30. For example, when the user blinks, the manipulation content analysis unit 160 may recognize the blinking as an instruction relating to selection of an input field. In this case, the manipulation content analysis unit 160 sequentially acquires an analysis result of an image of the eyeball u1 (for example, information indicating the image of the eyeball u1 and the pupil and iris region) from the image analysis unit 120 thereby detecting blinking based on the acquired analysis result.

For example, in a state in which the eyes are closed after blinking, the region of the whites of the eyes, the pupils, and the irises is not displayed in the image (in other words, a state in which the eyeball u1 is not exposed), and thus the pupil and iris region is not detected from the image. For this reason, the manipulation content analysis unit 160 may detect the timing at which the pupil and iris region is not detected as a timing at which blinking is not performed based on the acquired analysis result.

In addition, as another example, pixels corresponding to the region of the whites of the eyes tend to have higher pixel values (be bright) in comparison with pixels corresponding to the eyelids. For this reason, an image obtained when the whites of the eyes are captured (in other words, when the eyes are open) tends to have a higher average pixel value in the entire image than when the whites of the eyes are not captured (in other words, when the eyes are closed). For this reason, the manipulation content analysis unit 160 may detect the timing at which the average pixel value of images sequentially acquired from the image analysis unit 120 is equal to or lower than the threshold value as a timing at which blinking is performed.

In addition, when the user manipulates the manipulation unit 50 such as a predetermined button, the manipulation content analysis unit 160 may recognize the manipulation as an instruction relating to selection of an input field. In this case, the manipulation content analysis unit 160 recognizes that manipulation of the manipulation unit 50 (in other words, a manipulation relating to selection of an input field) has been performed by detecting a signal output from the manipulation unit 50 based on the manipulation made by the user.

Note that the example described above is merely an example, and the method of recognizing the instruction is not particularly limited as long as the manipulation content analysis unit 160 can recognize an instruction which relates to selection of an input field made by a user. For example, when the manipulation content analysis unit 160 detects a manipulation of shaking or tilting the information processing device 1, the manipulation content analysis unit may recognize the manipulation as an instruction of selecting an input field. It is needless to say that, in such a case, various kinds of sensors (for example, an acceleration sensor and an angular velocity sensor) for detecting a manipulation of shaking or tilting the information processing device 1 should be provided in the information processing device 1.

In the event of recognizing an instruction relating to selection of an input field made by a user, the manipulation content analysis unit 160 notifies the control unit 100 of the fact that the instruction has been given. Accordingly, the display control unit 104 of the control unit 100 can recognize the instruction relating to the selection of an input field from the user.

Hereinabove, the functional configuration of the information processing device 1a according to the second embodiment has been described. Note that the manipulation unit 50 described above can be realized by the manipulation device 913 shown in FIG. 2. In addition, the manipulation content analysis unit 160 and the control unit 100 (particularly, the user information acquisition unit 102 and the display control unit 104) can be realized by, for example, the processor 901 shown in FIG. 2. Note that the remaining functional configuration is the same as that of the information processing device 1 according to the first embodiment described above.

### 2.3. Process Flow

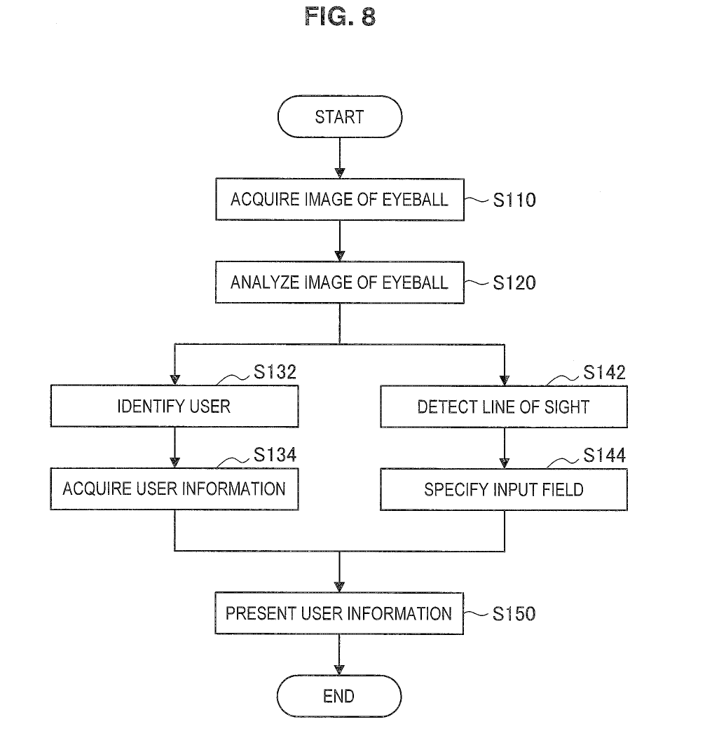

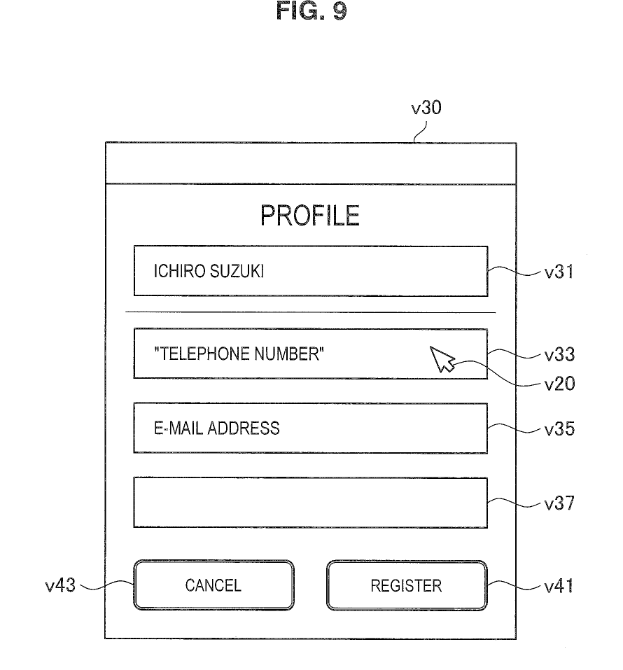

Next, the flow of a series of processes of the information processing device 1 according to the present embodiment will be described with reference to FIG. 8. FIG. 8 is a flowchart showing an example of the flow of the series of processes of the information processing device 1 according to the present embodiment

(Step S110)

The imaging unit 12 captures an image (still image or dynamic image) of the eyeball u1 and then outputs the captured image of the eyeball u1 to the information processing unit 10. The image acquisition unit 110 acquires the image of the eyeball u1 captured by the imaging unit 12 from the imaging unit 12. The image acquisition unit 110 provides the captured image to the image analysis unit 120. The image analysis unit 120 acquires the image of the eyeball u1 captured by the imaging unit 12 from the image acquisition unit 110. The image analysis unit 120 extracts information necessary for the detection of the direction of the line of sight r20 and the identification of a user from the image by performing an analysis process on the acquired image.

For example, when the iris recognition technology is used as a user identification method, the image analysis unit 120 extracts the pupil and iris region from the acquired image of the eyeball u1. Note that description will be provided hereinbelow on the assumption that the iris recognition technology is used as the user identification method. The image analysis unit 120 outputs the extracted information indicating the pupil and iris region and the acquired image of the eyeball u1 to the line of sight detection unit 130 and the user identification unit 140 respectively.

The user identification unit 140 acquires the image of the eyeball u1 and the information indicating the pupil and iris region from the image analysis unit 120. The user identification unit 140 outputs the acquired image of the eyeball u1 and information indicating the pupil and iris region to the feature quantity extraction unit 142 and then instructs the feature quantity extraction unit 142 to extract the feature quantity of the iris pattern based on the image of the eyeball u1.

The feature quantity extraction unit 142 acquires the image of the eyeball u1 and the information indicating the pupil and iris region from the user identification unit 140, and receives the instruction relating to extraction of the feature quantity of the iris pattern from the user identification unit 140.

The feature quantity extraction unit 142 extracts the region that corresponds to the iris from the image of the eyeball u1 based on the information indicating the pupil and iris region and then detects the iris pattern from the extracted region. Then, the feature quantity extraction unit 142 extracts the feature quantity of the iris pattern necessary for performing iris recognition from the detected iris pattern.

The feature quantity extraction unit 142 outputs information indicating the feature quantity of the iris pattern extracted from the image of the eyeball u1 to the determination unit 144.

The determination unit 144 acquires the information indicating the feature quantity of the iris pattern extracted from the image of the eyeball u1 from the feature quantity extraction unit 142. The determination unit 144 compares the acquired feature quantity of the iris pattern to feature quantities of iris patterns acquired from users in advance to specify a user who corresponds to the acquired feature quantity of the iris pattern.

The determination unit 144 outputs the specified information indicating the user (for example, the user ID d102) to the control unit 100. When information indicating a user is acquired from the user identification unit 140, the control unit 100 supplies the acquired information indicating the user (user ID d102) to the user information acquisition unit 102.

The user information acquisition unit 102 searches the user information d10 using the information indicating the user acquired from the control unit 100 as a search key, and then extracts other pieces of user information (for example, the name d104, the e-mail address d106, and the password d108 in FIG. 7) which are associated with the search key (i.e., the user ID d102). The user information acquisition unit 102 outputs the other pieces of user information acquired from the user information d10 based on the information indicating a user to the display control unit 104.

(Step S142)

The line of sight detection unit 130 specifies the position of the pupil in the image of the eyeball u1 based on the acquired information indicating the pupil and iris region, and then detects the direction of the line of sight r20 based on the specified position of the pupil. For example, the line of sight detection unit 130 may detect the direction of the line of sight r20 based on the position of the pupil region in the acquired image. In addition, as another example, the line of sight detection unit 130 may detect the direction of the line of sight r20 based on a relative position of the pupil region to the region indicating the white of the eye. The line of sight detection unit 130 outputs information indicating the detected direction of the line of sight r20 to the control unit 100.

(Step S144)

When information indicating a detected direction of a line of sight r20 is acquired from the line of sight detection unit 130, the control unit 100 supplies the acquired information indicating the direction of the line of sight r20 to the display control unit 104. When a predetermined application is activated, the display control unit 104 acquires control information for causing the input screen v10 which is associated with the application to be displayed, and then causes the input screen v10 to be displayed on the display unit 30 based on the acquired control information.

In addition, the display control unit 104 acquires information indicating the direction of the line of sight r20 detected by the line of sight detection unit 130 from the control unit 100. The display control unit 104 causes the pointer v20 to be displayed in a position which is indicated by the acquired direction of the line of sight r20 on the screen displayed on the display unit 30. Specifically, the display control unit 104 specifies the position at which the line of sight intersects the screen displayed on the display unit 30 based on the relative positional relation between the starting point of the line of sight of the eyeball u1 indicated by the direction of the line of sight r20 and the direction of the line of sight, and the display unit 30. Then, the display control unit 104 causes the pointer v20 to be displayed at the specified position on the screen.

(Step S150)

In addition, when a predetermined manipulation is performed in the state in which the line of sight of the eyeball u1 indicates an input field on the input screen v10 (for example, the account input field v11 or the password input field v13 shown in FIGS. 4 and 5), the display control unit 104 recognizes that the input field has been selected. When an input field of the display screen v10 is selected, the display control unit 104 inputs the user information acquired by the user information acquisition unit 102 into the selected input field (in other words, causes the user information to be displayed). At this time, when the type of information that can be input into the selected input field is known, the display control unit 104 may input the information that can be input into the selected input field of the acquired user information into the input field.

As described above, the information processing device 1a identifies a user based on an image of the eyeball u1, and extracts user information of the identified user. Then, when an input field displayed on the screen is selected based on the input of the line of sight, the information processing device 1a inputs the user information of the identified user into the selected input field. With such a configuration, in the information processing device 1a according to the present embodiment, a user can quickly input user information relating to himself or herself into an input field displayed on the screen without performing a complicated manipulation such as manipulating a virtual keyboard through input of a line of sight.

### 3. EXAMPLES

Next, application examples of the information processing device 1 according to the first embodiment and the information processing device 1a according to the second embodiment described above will be described as examples.

### 3.1. Example 1

### Application Example to a Profile Input Screen

First, as Example 1, a case in which the specific example of input support performed in the information processing device 1a according to the second embodiment is applied to input support when information is input onto a profile input screen will be described. For example, FIG. 9 is a diagram for describing an overview of the information processing device 1a according to Example 1, showing an example of the profile input screen. Hereinbelow, the example in which information is input onto a profile input screen v30 shown in FIG. 9 will be described in association with the information processing device 1a according to Example 1.

As shown in FIG. 9, the profile input screen v30 includes a name input field v31, a telephone number input field v33, an e-mail address input field v35, an extra input field v37, a registration button v41, and a cancellation button v43. The name input field v31 is an input field into which the name of a user who registers his or her profile (who may be simply referred to hereinafter as a “user”) is input. In addition, the e-mail address input field v35 is an input field into which an e-mail address of the user is input.

In addition, the telephone number input field v33 is an input field into which a telephone number of the user is input. In the present example, description will be provided on the assumption that either of the telephone number of the user's residence (for example, the telephone number of a landline telephone) or the telephone number of a mobile telephone (mobile communication terminal) is input into the telephone number input field v33.

In addition, the extra input field v37 may be provided so that information other than the name, the telephone number, and the e-mail address can be registered as the profile. As a specific example, the address of the user's residence can be registered as the profile. Note that each of the input fields described above is merely an example, which does not indicate that the profile input screen v30 should necessarily include the input fields. The registration button v41 is an interface (for example, a button) for registering information input into the name input field v31, the telephone number input field v33, the e-mail address input field v35, and the extra input field v37 as a profile. In addition, the cancellation button v43 is an interface for calling off (cancelling) a manipulation relating to registration of the profile.

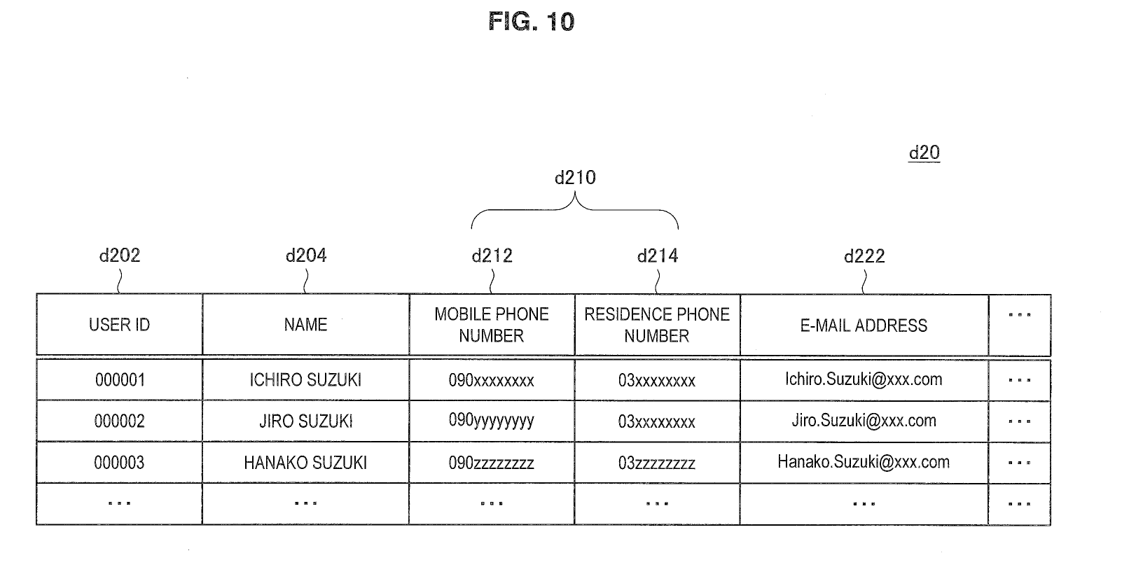

Herein, FIG. 10 will be referred to. FIG. 10 shows an example of user information d20 stored in the user information storage unit 150 in the information processing device 1a according to the present example. As shown in FIG. 10, the user information d20 includes a user ID d202, a name d204, a telephone number d210, and an e-mail address d222. Note that the user information d20 according to the present example includes a mobile phone number d212 and a residence phone number d214 as the telephone number d210.

The user ID d202 is an example of identification information (i.e., information indicating a user) for identifying a user, corresponding to the user ID d102 of the user information d10 shown in FIG. 7. The name d204 shows the name of a user indicated by the user ID d202. In the same manner, the e-mail address d222 shows an e-mail address of a user indicated by the user ID d202.

In addition, the mobile phone number d212 shows the telephone number of a mobile telephone (mobile communication terminal) such as a smartphone that is owned by a user indicated by the user ID d202. In the same manner, the residence phone number d214 shows the telephone number of the residence (for example, the telephone number of a landline telephone) of a user indicated by the user ID d202.

Note that each type of information included in the user information d20 described above is merely an example, and the type of information included in the user information d20 is not limited to the example described above as long as the information is of a user indicated by the user ID d202. As a specific example, the address of the residence of a user indicated by the user ID d202 may be registered in the user information d20. In addition, hereinbelow, description of the user information d20 is set to indicate the user information d20 stored in the user information storage unit 150 unless specified otherwise.

In the description of the information processing device 1a according to the present example, a user selects an input field into which information is input by manipulating the pointer v20 through an input of the line of sight. The information processing device 1a identifies a user based on the image of the eyeball u1 and extracts user information of the user from the user information d20 based on an identification result in the same manner as the information processing device 1a according to the second embodiment. Then, the information processing device 1a performs input support by inputting the extracted user information into the input field selected by the user through the input of the line of sight. Hereinbelow, an example of the input support by the information processing device 1a will be described.

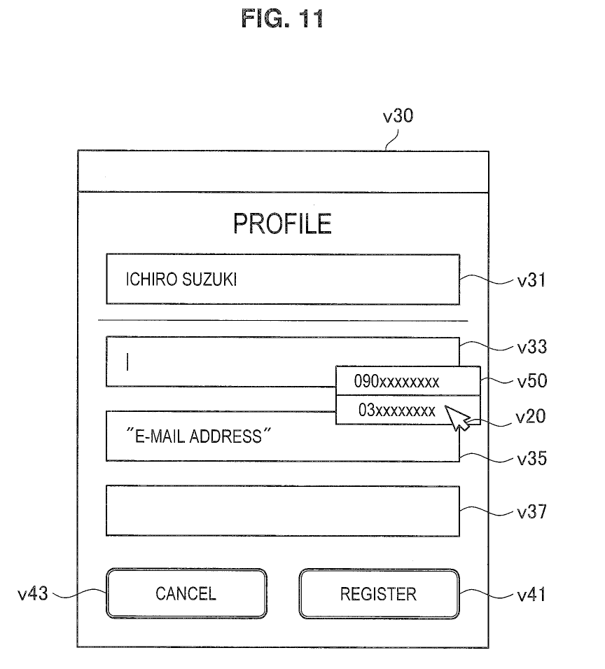

First, FIG. 11 will be referred to. FIG. 11 is a diagram for describing an example of an input method of information in the information processing device 1a according to the present example, showing an example of an interface for inputting information into the telephone number input field v33 when the telephone number input field v33 is selected. Note that, herein, the telephone number input field v33 is set to be associated in advance with the type of information corresponding to the telephone number d210 of the user information d20 shown in FIG. 10. There are a plurality of pieces of information denoted as the mobile phone number d212 and the residence phone number d214 as information corresponding to the telephone number d210 as shown in FIG. 10. In other words, in such a case, there are a plurality of candidates for information that can be input into the telephone number input field v33.

As such, when there are a plurality of candidates for information that can be input into a selected input field, the display control unit 104 of the information processing device 1a may cause a list of the candidates to be presented as a sub screen v50 and then cause information selected by the user from the candidates presented on the sub screen v50 to be input into the input field. For example, in the example shown in FIG. 11, the display control unit 104 causes information corresponding to the mobile phone number d212 and information corresponding to the residence phone number d214 serving as the candidates for information that can be input into the telephone number input field v33 to be presented as the sub screen v50.

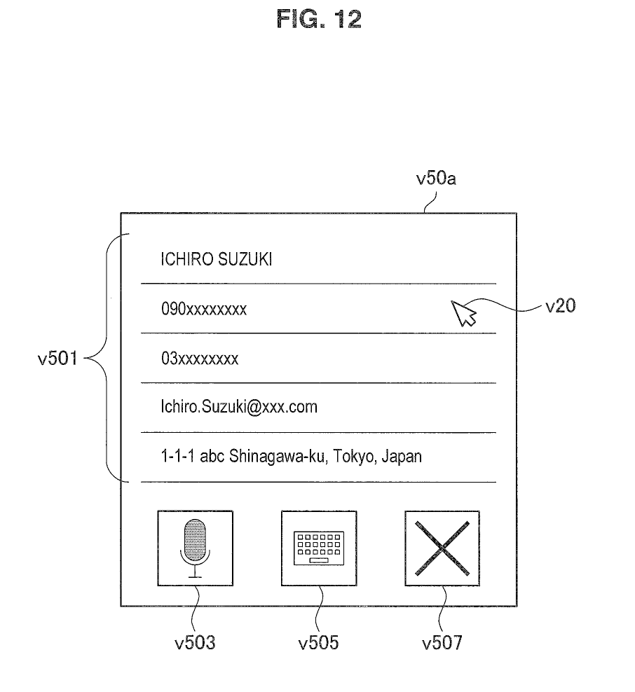

In addition, when any of the input fields is selected, the display control unit 104 may cause some or all of the extracted user information to be displayed as a sub screen v50a regardless of the type of information. For example, FIG. 12 is a diagram for describing an example of an input method of information in the information processing device according to the present example, showing an example of the sub screen v50a. In the example shown in FIG. 12, as an extracted user information list d501, the name d204, the mobile phone number d212, the residence phone number d214, the e-mail address d222, and the address of the user are present on the sub screen v50a.

In addition, there may be cases in which information corresponding to a selected input field is not included in the extracted user information list d501. For this reason, an interface (for example, a button) for inputting information using another input method may be provided on the sub screen v50a. For example, in the example shown in FIG. 12, the sub screen v50a includes a voice input button v503 and a keyboard button v505. The voice input button v503 is a button for activating an interface for inputting information through an input of a voice. In the same manner, the keyboard button v505 is a button for displaying a virtual keyboard for inputting information.

In addition, the sub screen v50a may include a cancellation button v507 for calling off (cancelling) input of information input into a selected input field.

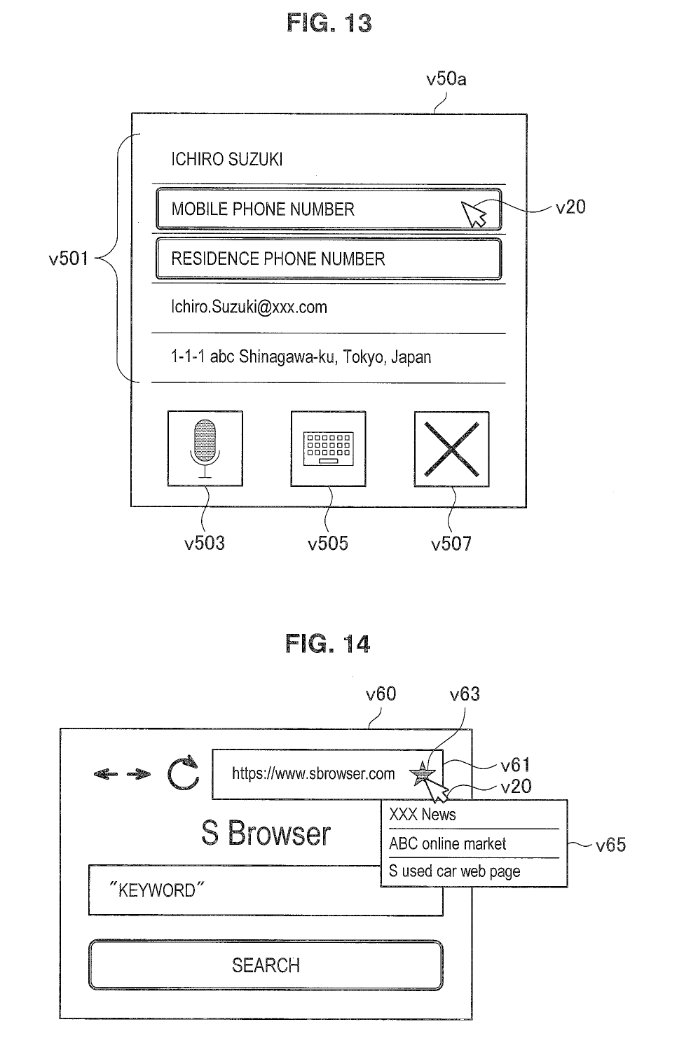

In addition, the display control unit 104 may cause at least some information of the user information list d501 presented on the sub screen v50a to be replaced with other text or an image and then presented. For example, FIG. 13 is a diagram for describing an example of an input method of information in the information processing device 1a according to the present example, showing an example in which some information of the user information list d501 presented on the sub screen v50a is replaced with other text or an image and then presented.

In the example shown in FIG. 13, information corresponding to the mobile phone number d212 and the residence phone number d214 of the user information list d501 is masked and only the type of the user information is presented. In this manner, by replacing some user information with other text or an image and then presenting the information, leakage of private information that occurs when the sub screen v50a displayed on the screen is viewed surreptitiously can be prevented.

As described above, the information processing device 1a according to the present example may present the sub screen v50a as shown in FIG. 12 when an input field is selected. With this configuration, for example, even when the type of information that can be input is not associated with the selected input field, a user can input information into the input field by selecting the information to be input into the input field from the presented user information.

### 3.2. Example 2

### Application Example to a Browser

Next, the information processing device 1 according to Example 2 will be described. In Example 2, an example in which the information processing device 1a according to the second embodiment is applied to control of a browser and, for each user who is identified based on an image of the eyeball u1, a list of bookmarks which are registered in advance by the user is presented will be described with reference to FIG. 14. FIG. 14 is a diagram for describing an overview of the information processing device 1a according to Example 2, showing an example of the browser according to the present example.

As shown in FIG. 14, the browser v60 includes a uniform resource locator (URL) input field v61, and a bookmark display button v63. When a user manipulates the bookmark display button v63 using the pointer v20 through an input of the line of sight, the information processing device 1a causes a sub screen v65 on which the list of bookmarks is presented to be displayed. At that moment, the information processing device 1a according to the present example acquires information of the bookmarks registered in advance by the user as user information of the user who has been identified based on an image of the eyeball u1 and then presents the sub screen v65 on which the list of the acquired bookmarks is presented.

Note that, in such a case, information of bookmarks registered in advance by each user may be stored in the user information storage unit 150 in association with identification information for identifying the user as user information.

Hereinabove, in the information processing device 1a according to the present example, a user can be identified based on an image of the eyeball u1 captured by the imaging unit 12, and a list of bookmarks which is associated with the identified user can be presented on the browser v60 as the sub screen v65. Accordingly, the user can select a desired bookmark from the list of bookmarks which the user has registered before through an input of the line of sight.

### 3.3. Example 3

### Application Example to an Activation Menu of an Application

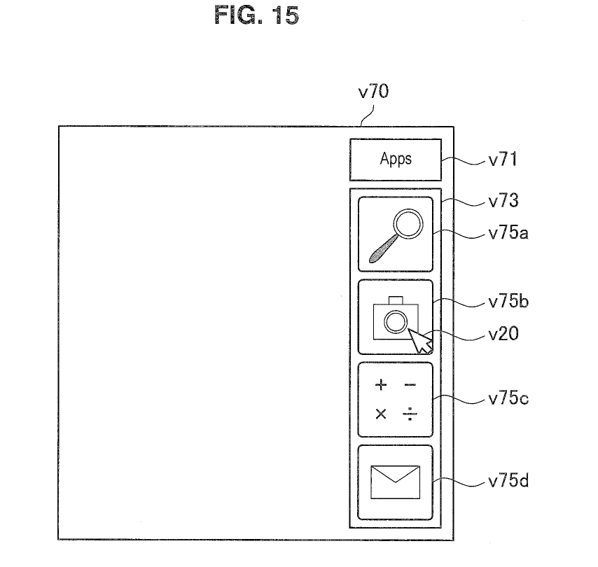

Next, the information processing device 1 according to Example 3 will be described. In Example 3, an example of activating an application in which setting information (configuration parameters) of each application is stored in, for example, the user information storage unit 150 as user information and then the setting information of an identified user is read at the time of activation of the application will be described. Herein, FIG. 15 will be referred to. FIG. 15 is a diagram for describing an overview of the information processing device 1 according to Example 3, showing an example of an activation screen v70 of an application.

In FIG. 15, reference numeral v73 indicates a sub screen (for example, a launcher or a manipulation panel) on which icons v75a to v75d for activating each of applications are presented. Note that the icons v75a to v75d may be denoted hereinafter simply as an “icon v75” when the icons are not particularly distinguished. In addition, a sub screen display button v71 is an interface (for example, a button) for switching display and non-display of the sub screen v73. In the example shown in FIG. 15, a user causes the sub screen v73 to be displayed by manipulating the sub screen display button v71 using the pointer v20 through an input of the line of sight, and then causes a desired application to be activated by manipulating a desired icon v75 on the sub screen v73.

At that moment, the information processing device 1 according to the present example acquires setting information corresponding to the selected icon v75 among pieces of setting information registered in advance as user information of the user identified based on an image of the eyeball u1. Then, the information processing device 1 activates the application corresponding to the selected icon v75 and then changes the setting of the activated application based on the acquired setting information.

Note that, in such a case, the setting information of each application registered in advance for each user may be stored in the user information storage unit 150 in association with the identification information for identifying the user as the user information. Then, the control unit 100 of the information processing device 1 may use, for example, information of the application corresponding to the icon v75 selected by the user through an input of the line of sight and information of the identified user as search keys to extract the setting information corresponding to the search keys from the user information storage unit 150. Note that the configuration of extracting the setting information from the user information storage unit 150 (for example, the configuration of a part of the control unit 100) corresponds to an example of a “setting information acquisition unit.” In addition, the configuration of changing the setting of an application based on the extracted setting information (for example, the configuration of a part of the control unit 100) corresponds to an example of an “application control unit.”

In the information processing device 1 according to the present example described hereinabove, when an application is activated, the setting of the application can be changed based on setting information corresponding to a user identified based on an image of the eyeball u1 captured by the imaging unit 12. For this reason, the user can activate the application in the state in which the setting that the user has registered in advance is reflected only by instructing the activation of the application without performing a complicated manipulation such as changing the setting.

### 3.4. Example 4

### Application Example to User Authentication

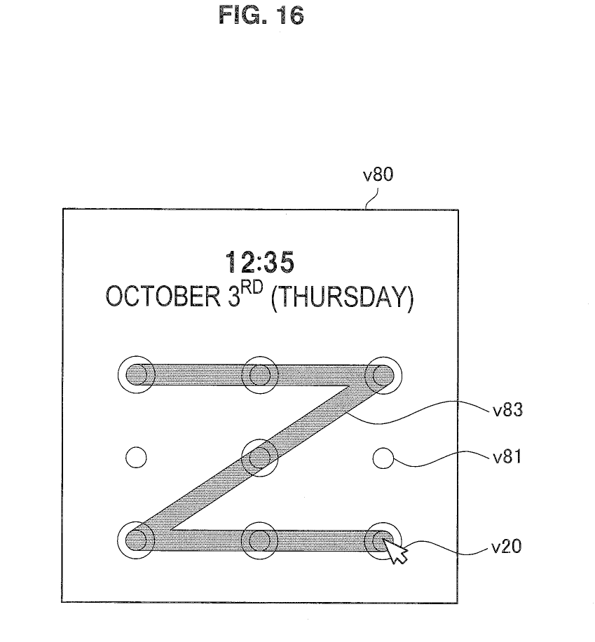

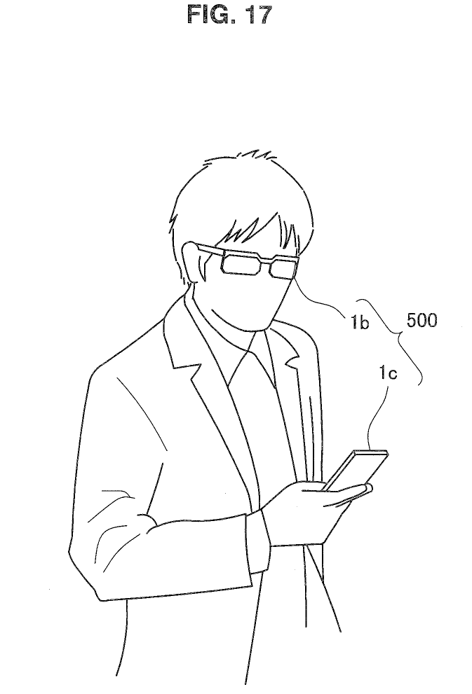

Next, as Example 4, an example in which the information processing device 1 according to the first embodiment is applied to user authentication will be described. In the information processing device 1 according to the present example, authentication of a user is reinforced by combining identification of the user based on an image of the eyeball u1 described above and authentication using a method different from the identification method. Herein, FIG. 16 will be referred to. FIG. 16 is a diagram for describing an overview of the information processing device according to Example 4, showing an example of an authentication screen v80 according to the present example. The authentication screen v80 shown in FIG. 16 shows an example of an authentication screen on which a user is authenticated based on a manipulation pattern v83 formed by connecting an arbitrary number of spots v81 among a plurality of spots v81 displayed on the screen in a pre-decided order.

In the example shown in FIG. 16, the information processing device 1 according to the present example stores information indicating the manipulation pattern v83 for authentication which has been registered in advance for each user in the user information storage unit 150 in association with identification information for identifying the user. Then, the information processing device 1 identifies the user based on the image of the eyeball u1 captured by the imaging unit 12, and then extracts the manipulation pattern v83 corresponding to the identified user from the user information storage unit 150. Note that the configuration of extracting the manipulation pattern v83 from the user information storage unit 150 (for example, the configuration of a part of the control unit 100) corresponds to an example of an “authentication information acquisition unit.”

Next, the information processing device 1 recognizes the manipulation pattern v83 input by the user through an input of the line of sight based on the direction of the line of sight r20. Then, the information processing device 1 compares the recognized manipulation pattern v83 based on the input of the line of sight to the manipulation pattern v83 extracted as user information of the identified user, and thereby authenticates the user. Note that the configuration of authenticating a user by comparing the manipulation pattern v83 based on the input of the line of sight to the manipulation pattern v83 extracted as user information (for example, the configuration of a part of the control unit 100) corresponds to an example of an “authentication processing unit.”

Note that, although the case in which a user is authenticated based on the manipulation pattern v83 has been described in the above example, the method is not particularly limited as long as a user can be authenticated with information input through an input of the line of sight. Hereinabove, in the information processing device 1 according to the present example, a user is authenticated based on both of identification (authentication) of the user based on an image of the eyeball u1 captured by the imaging unit 12 and authentication through an input of the line of sight (for example, authentication using a manipulation pattern). For this reason, the information processing device 1 according to the present example can solidify the security level in comparison with the case in which a user is authenticated through only one of the authentication schemes.

### 4. Third embodiment

### 4.1. Overview of an Information Processing Device

Next, an overview of an information processing system 500 according to a third embodiment of the present disclosure will be described with reference to FIG. 17. FIG. 17 is a diagram for describing the overview of the information processing system 500 according to the third embodiment of the present disclosure. As shown in FIG. 17, the information processing system 500 according to the present embodiment includes information processing devices 1b and 1c.

The information processing device 1b can be configured as a head-mount-type display (for example, an eyeglass-type display) such that, for example, when a user wears the information processing device on his or her head, a display unit thereof is held in front of the user's eyes (for example, in the vicinity of the front of the eyeball u1). Note that the display unit of the information processing device 1b may be described as a “display unit 30b ” hereinbelow.

In addition, the information processing device 1c is constituted by a housing differently from the information processing device 1b, and configured as an information processing device with a display unit. The information processing device 1c may be, for example, a portable information processing terminal such as a smartphone, or an information processing terminal such as a PC. Note that the display unit of the information processing device 1c may be described as a “display unit 30c ” hereinbelow. By configuring the display unit 30b of the information processing device 1b with a transmissive-type display, the information processing system 500 according to the present embodiment causes information displayed on the display unit 30b to be superimposed on information displayed on the display unit 30c of the information processing device 1c.

Here, since the display unit 30b is held in front of the user's eyes (i.e., in the vicinity of the front of the eyeball u1), information displayed thereon has a low possibility of being viewed surreptitiously by another user in comparison with the display unit 30c. For this reason, in the information processing system 500, user information such as an e-mail address or a telephone number (particularly, information of high confidentiality) is displayed on the display unit 30b side and other information (for example, an input screen or the like) is displayed on the display unit 30c side. With the above configuration, a user can input user information of high confidentiality such as his or her e-mail address, telephone number, or password in the information processing system 500 according to the present embodiment without it being viewed surreptitiously by another user. Hereinbelow, details of the information processing system 500 according to the present embodiment will be described.

### 4.2. Functional Configuration of the Information Processing Device

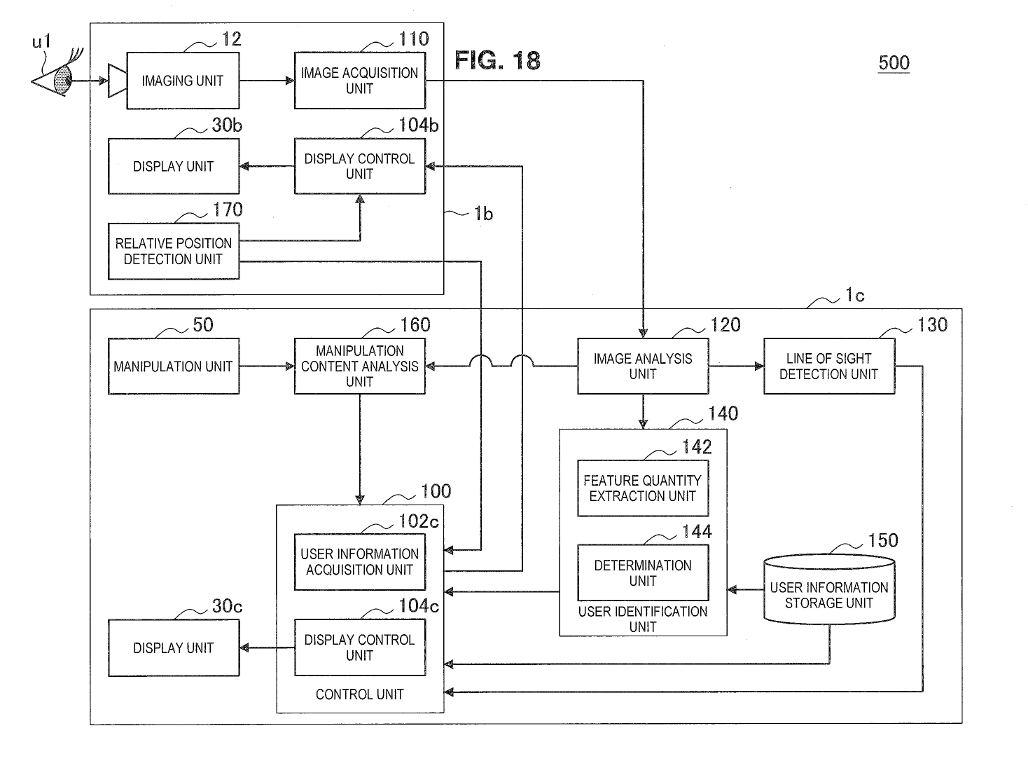

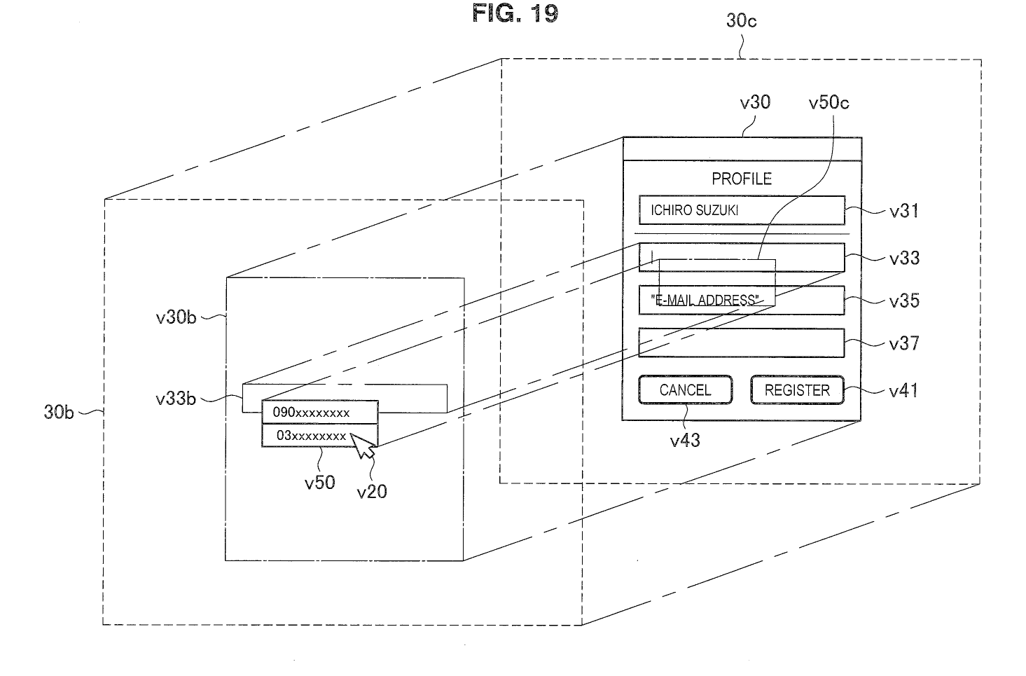

A functional configuration of the information processing system 500 according to the present embodiment, i.e., the information processing devices 1a and 1b, will be described with reference to FIG. 18. FIG. 18 is a block diagram showing an example of the functional configuration of the information processing system 500 according to the present embodiment. Note that, herein, a case in which each piece of the information included in the user information d20 (for example, the name d204, the mobile phone number d212, the residence phone number d214, or the e-mail address d222) shown in FIG. 10 is input into an input field of the profile input screen v30 shown in FIG. 9 will be described as an example with reference to FIGS. 9 and 10 together.

As shown in FIG. 18, the information processing device 1b includes the imaging unit 12, the image acquisition unit 110, a display control unit 104b, the display unit 30b, and a relative position detection unit 170. In addition, the information processing device 1c includes the image analysis unit 120, the line of sight detection unit 130, the user identification unit 140, the user information storage unit 150, the manipulation content analysis unit 160, the manipulation unit 50, the control unit 100, and the display unit 30c. In addition, the control unit 100 includes a user information acquisition unit 102c and a display control unit 104c.

Note that the imaging unit 12, the image acquisition unit 110, the image analysis unit 120, the line of sight detection unit 130, the user identification unit 140, the user information storage unit 150, the manipulation content analysis unit 160, and the manipulation unit 50 are the same as those of the information processing device 1a according to the second embodiment described above. For this reason, the following description will focus on operations of the relative position detection unit 170, the user information acquisition unit 102c, the display control unit 104c, the display unit 30c, the display control unit 104b, and the display unit 30b which are different from those of the information processing device 1a according to the second embodiment described above, and detailed description with regard to other configurations will be omitted. In addition, in the drawing shown in FIG. 18, a constituent element equivalent to a communication unit is not illustrated, however, it is needless to say that, when each of the constituent elements of the information processing device 1b performs transmission and reception of information with each of the constituent elements of the information processing device 1c, transmission and reception of information may be performed through wireless or wired communication.

(Relative Position Detection Unit 170)

The relative position detection unit 170 detects information indicating a relative position of the information processing device 1b with respect to the display unit 30c of the information processing device 1c, the distance between the display unit 30c and the information processing device 1b, and a relative orientation of the information processing device 1b with respect to the display unit 30c (which may be collectively referred to hereinafter as a “relative position”). As a specific example, the relative position detection unit 170 may capture a marker provided in the information processing device 1c serving as a reference for determining a relative position using the imaging unit that can capture still images or dynamic images, analyze feature quantities of the captured marker (for example, the position, orientation, or size of the marker), and thereby detect a relative position.

Note that, in the present specification, the term “marker” is assumed to mean any object present in a real space generally having a known pattern. In other words, the marker can include, for example, a real object, a part of a real object, a figure, a symbol, a string of letters, or a pattern shown on a surface of a real object, an image displayed by a display, or the like. There are cases in which the term “marker” refers to a special object prepared for a certain application in a narrow sense, however, the technology according to the present disclosure is not limited to such cases. For example, by displaying a marker on the display unit 30c of the information processing device 1c, the relative position detection unit 170 may detect a relative position based on the marker.

As described above, by detecting a relative position of the information processing device 1b with respect to the display unit 30c, the display control unit 104c to be described later can recognize which part of a screen displayed on the display unit 30c the line of sight of the user points to based on the detected relative position and the direction of the line of sight r20. In addition, the display control unit 104c to be described later can recognize to which position on the screen displayed on the display unit 30c a position on the screen displayed on the display unit 30b corresponds based on the detected relative position. For this reason, the display control unit 104c can control a display position of display information such that the display information displayed on the display unit 30b is superimposed in a desired position on the screen displayed on the display unit 30c. Note that the position on the screen displayed on the display unit 30c may described as a “position on the display unit 30c ” hereinafter. In the same manner, a position on the screen displayed on the display unit 30b may be described as a “position on the display unit 30b.”

The relative position detection unit 170 outputs information indicating the detected relative position of the information processing device 1b with respect to the display unit 30c (which may be referred to hereinafter as “relative position information”) to the display control unit 104b and the control unit 100. Note that a timing at which the relative position detection unit 170 detects the relative position may be appropriately decided in accordance with management thereof. As a specific example, the relative position detection unit 170 may detect a relative position at each timing decided in advance (in real time). In addition, as another example, when a predetermined process is executed in the information processing device 1b or the information processing device 1c, the relative position detection unit 170 may detect a relative position in connection with the process.

In addition, a position in which the relative position detection unit 170 is provided is not limited as long as the relative position detection unit can detect a relative position of the information processing device 1b with respect to the display unit 30c. For example, when a relative position is detected by analyzing a marker captured as described above, the configuration relating to the capturing of the marker may be provided in the information processing device 1b and the configuration relating to the analysis of the captured marker may be provided in the information processing device 1c. In addition, the relative position detection unit 170 may be provided on the information processing device 1c side. In this case, for example, a relative position may be detected in such a way that a marker is provided on the information processing device 1b side, the marker is captured by the imaging unit provided on the information processing device 1c side, and then the captured marker is analyzed.

In addition, the method for detecting a relative position described above is merely an example, and the method is not limited as long as the relative position detection unit 170 can detect a relative position of the information processing device 1b with respect to the display unit 30c. For example, by providing various sensors (for example, an acceleration sensor and an angular velocity sensor) in the information processing device 1b, a relative position of the information processing device 1b with respect to the display unit 30c may be detected using the sensors. In addition, it is needless to say that the configuration of the relative position detection unit 170 may be arbitrarily changed in accordance with the method for detecting a relative position.

(Control Unit 100)

The control unit 100 acquires information indicating the user who has been identified based on the images of the eyeball u1 captured by the imaging unit 12 from the determination unit 144 of the user identification unit 140. In addition, the control unit 100 acquires information indicating the detected direction of the line of sight r20 from the line of sight detection unit 130. When information indicating a user (for example, user ID d202 shown in FIG. 10) is acquired from the user identification unit 140, the control unit 100 supplies the acquired information indicating the user to the user information acquisition unit 102c. When information indicating a detected direction of a line of sight r20 is acquired from the line of sight detection unit 130, the control unit 100 supplies the acquired information indicating the direction of the line of sight r20 to the display control unit 104c.

In addition, the control unit 100 acquires the relative position information from the relative position detection unit 170. When the relative position information is acquired from the relative position detection unit 170, the control unit 100 supplies the acquired relative position information to the display control unit 104c.

(User Information Acquisition Unit 102c)

The user information acquisition unit 102c acquires the information indicating a user (i.e., the user ID d202) from the control unit 100. The user information acquisition unit 102c searches the user information d20 stored in the user information storage unit 150 using the acquired information indicating a user as a search key, and then extracts other pieces of user information (for example, the name d204, the mobile phone number d212, the residence phone number d214, and the e-mail address d222 in the case of the user information d20) associated with the search key (i.e., the user ID d202). The user information acquisition unit 102c outputs the other pieces of user information acquired from the user information d20 based on the information indicating a user to the display control unit 104c.

(Display Control Unit 104c and Display Control Unit 104b)

Next, operations of the display control unit 104c and the display control unit 104b will be described. As described above, in the information processing system 500 according to the present embodiment, one portion of information presented to a user (display information) is displayed on the display unit 30c side and the other portion of the information is displayed on the display unit 30b side so as to be superimposed on the information displayed on the display unit 30c. Such control is realized by linking the display control unit 104c of the information processing device 1c to the display control unit 104b of the information processing device 1b.

Herein, FIG. 19 will be referred to. FIG. 19 is a diagram for describing an example of an information display method of the information processing system 500 according to the present embodiment. FIG. 19 shows an example in which information is input into each of the input fields (for example, the name input field v31, the telephone number input field v33, the e-mail address input field v35, and the extra input field v37) of the profile input screen v30 displayed on the display unit 30b. Note that the method for inputting information into each of the input fields is the same as the case of the information processing device 1a according to the second embodiment described above.

Meanwhile, in the information processing system 500 according to the present embodiment, one portion of information is displayed on the display unit 30c side and another portion of the information is displayed on the display unit 30b side. For example, in the example shown in FIG. 19, the information processing system 500 causes user information (i.e., the name of a user) which corresponds to (is input into) the profile input screen v30, each of the input fields on the profile input screen v30, and the name input field v31 to be displayed on the display unit 30c side. On the other hand, the information processing system 500 causes user information which corresponds to the telephone number input field v33 (for example, the mobile phone number d212 and the residence phone number d214 shown in FIG. 10) and the sub screen v50 on which the user information is presented to be displayed on the display unit 30b. Accordingly, the operation of the display control unit 104c and the display control unit 104b will be described hereinbelow based on the example shown in FIG. 19.

When a predetermined application is activated, the display control unit 104c acquires control information for causing the input screen (for example, the profile input screen v30 shown in FIG.19) which is associated with the application to be displayed, and then causes the input screen v10 to be displayed on the display unit 30 based on the acquired control information.

In addition, the display control unit 104c notifies the display control unit 104b of information indicating the input screen displayed on the display unit 30c and position information of the input screen on the display unit 30c. Accordingly, the display control unit 104b can recognize the type of the input screen displayed on the display unit 30c and display positions of the input screen on the display unit 30c and each of information displayed on the input screen (for example, the input fields and the interface such as a button).

In addition, the display control unit 104c acquires the relative position information transmitted from the relative position detection unit 170 and the information indicating the direction of the line of sight r20 detected by the line of sight detection unit 130 from the control unit 100.

The display control unit 104c computes the position indicated by the line of sight of the eyeball u1 on the display unit 30c based on the acquired relative position information and information indicating the direction of the line of sight r20. Specifically, the display control unit 104c computes a relative position of the information processing device 1b with respect to the display unit 30c (in other words, a relative position of the information processing device 1b with respect to the display unit 30c, the distance between the display unit 30c and the information processing device 1b, and a relative orientation of the information processing device 1b with respect to the display unit 30c) based on the acquired relative position information. By computing the relative position of the information processing device 1b with respect to the display unit 30c in this manner, the display control unit 104c estimates the relative position of the eyeball u1 with respect to the display unit 30c (in other words, the relative position, the orientation, and the distance).

Based on the relative position of the eyeball u1 with respect to the display unit 30c and the direction of the line of sight r20, the display control unit 104c computes the position of the starting point of the line of sight of the eyeball u1 and the direction in which the line of sight faces with respect to the display unit 30c. Then, the display control unit 104c specifies the position at which the line of sight intersects the screen displayed on the display unit 30c.

When the position on the display unit 30c indicated by the line of sight of the eyeball u1 is specified, the display control unit 104c notifies the display control unit 104b of information indicating the specified position. Here, an operation of the display control unit 104b will be focused on. The display control unit 104b acquires the relative position information indicating the relative position of the information processing device 1b with respect to the display unit 30c from the relative position detection unit 170. The display control unit 104b associates a position on the display unit 30b with the position on the display unit 30c based on the acquired relative position information. Accordingly, when the display unit 30b is caused to display information, the display control unit 104b can cause the display unit 30b to display the information so as to be superimposed on the desired position on the display unit 30c. For example, a region v30b of FIG. 19 indicates a region on the display unit 30b which corresponds to the profile input screen v30 displayed on the display unit 30c.

In addition, the display control unit 104b acquires the information indicating the input screen displayed on the display unit 30c and the position information of the input screen on the display unit 30c from the display control unit 104c. The display control unit 104b can recognize the type of the input screen displayed on the display unit 30c and display positions of the input screen on the display unit 30c and each piece of information displayed on the input screen based on the acquired information indicating the input screen and position information of the input screen.

In addition, the display control unit 104b acquires information indicating the position indicated by the line of sight of the eyeball u1 on the display unit 30c from the display control unit 104c. Accordingly, the display control unit 104b recognizes the position indicated by the line of sight of the eyeball u1 (i.e., indicated through the input of the line of sight) on the display unit 30c. At this time, the display control unit 104b may display the pointer v20 at the position on the display unit 30b which corresponds to the position indicated by the line of sight of the eyeball u1 on the display unit 30c.

Next, an operation of the display control units 104c and 104b performed when each of the input fields on the profile input screen v30 shown in FIG. 19 is selected through the input of the line of sight will be described. Note that, since an operation relating to selection of an input field is the same as that of the information processing device 1a according to the second embodiment described above, detailed description thereof will be omitted.

When an input field on the profile input screen v30 is selected, the display control unit 104c determines whether user information corresponding to the selected input field is information that is to be displayed on the display unit 30c or the display unit 30b. Note that the display control unit 104c may store control information indicating which piece of user information of acquired user information should be displayed on which of the display unit 30b and the display unit 30c in advance. In addition, as another example, the control information may be associated with each piece of the user information in advance. In other words, based on the control information, the display control unit 104c may determine on which of the display unit 30c and the display unit 30b each piece of the user information should be displayed.

Note that which piece of the user information should be displayed on which of the display unit 30b and the display unit 30c may be arbitrarily set by, for example, a user or an administrator of the information processing system 500 in accordance with management thereof. As a specific example, among pieces of information extracted from the user information d20 shown in FIG. 10, information of high confidentiality (for example, the mobile phone number d212 and the residence phone number d214) may be set to be displayed on the display unit 30b and other information may be set to be displayed on the display unit 30c. With this configuration, the information processing system 500 according to the present embodiment can cause the information of high confidentiality to be displayed on the display unit 30b side that has a low possibility of displayed information being viewed surreptitiously by another user.

Herein, FIG. 19 will be referred to again. First, an operation of the display control unit 104c performed when user information corresponding to the selected input field is information to be displayed on the display unit 30c will be described exemplifying a case in which the name d204 of the acquired user information is input into the name input field v31. When the name input field v31 is selected, the display control unit 104c extracts the name d204 from the acquired user information as information that can be input into the name input field v31. The display control unit 104c recognizes the name d204 as information to be displayed on the display unit 30c based on control information associated with the extracted name d204. In this case, the display control unit 104c causes the extracted name d204 to be displayed in the name input field v31 displayed on the display unit 30c.

Next, an operation of the display control units 104c and 104b performed when user information corresponding to the selected input field is information to be displayed on the display unit 30b will be described exemplifying a case in which the mobile phone number d212 or the residence phone number d214 of the acquired user information is input into the telephone number input field v33. Note that, herein, a case in which the display control units 104c and 104b receive the selection of the telephone number input field v33 and cause the sub screen v50 on which the mobile phone number d212 and the residence phone number d214 that can be input into the telephone number input field v33 are presented to be displayed will be described.

When the telephone number input field v33 is selected, the display control units 104c extracts the mobile phone number d212 and the residence phone number d214 from the acquired user information as information that can be input into the telephone number input field v33. Based on control information associated with the extracted mobile phone number d212 and residence phone number d214, the display control units 104c recognizes the mobile phone number d212 and the residence phone number d214 as information to be displayed on the display unit 30b. In this case, the display control units 104c transmits information indicating the selected telephone number input field v33 and the extracted mobile phone number d212 and residence phone number d214 to the display control unit 104b.

The display control unit 104b recognizes that the telephone number input field v33 has been selected based on the information indicating the telephone number input field v33 acquired from the display control units 104c. In addition, the display control unit 104b specifies the region v33b corresponding to the telephone number input field v33 on the display unit 30b based on the position information of the input screen (i.e., the profile input screen v30) on the display unit 30c which has been acquired in advance.

Next, the display control unit 104b generates the sub screen v50 on which the mobile phone number d212 and the residence phone number d214 are presented based on the mobile phone number d212 and the residence phone number d214 acquired from the display control unit 104c. The display control unit 104b causes the generated sub screen v50 to be displayed in the vicinity of the region v33b on the display unit 30b. Accordingly, when the user views the display unit 30c looking through the display unit 30b, he or she can recognize that the sub screen v50 is superimposed on a region v50c in the vicinity of the telephone number input field v33 on the display unit 30c.

In addition, the user is assumed to select any of the mobile phone number d212 and the residence phone number d214 presented on the sub screen v50 through an input of the line of sight. In this case, the display control unit 104b recognizes the information selected by the user out of the mobile phone number d212 and the residence phone number d214 based on information indicating the position indicated by the line of sight of the eyeball u1 on the display unit 30c which has been notified of by the display control unit 104c.

When any of the mobile phone number d212 and the residence phone number d214 presented on the sub screen v50 is selected, the display control unit 104b causes the selected user information to be displayed in the region v33b on the display unit 30b. Accordingly, when the user views the display unit 30c looking through the display unit 30b, he or she can recognize that the user information he or she has selected is input into (in other words, is displayed as if it were superimposed on) the telephone number input field v33 on the display unit 30c.

As described above, by configuring the display unit 30b of the information processing device 1b with a transmissive-type display, the information processing system 500 according to the present embodiment causes information displayed on the display unit 30b to be superimposed on information displayed on the display unit 30c of the information processing device 1c. At this time, in the information processing system 500, user information such as an e-mail address or a telephone number (particularly, information of high confidentiality) may be displayed on the display unit 30b side and other information (for example, an input screen or the like) may be displayed on the display unit 30c side. With the above configuration, a user can input user information of high confidentiality such as his or her e-mail address, telephone number, or password in the information processing system 500 according to the present embodiment without it being viewed surreptitiously by another user.

### 5. CONCLUSION

As described above, the information processing device 1 and the information processing system 500 according to the present disclosure analyzes an image of the eyeball u1 captured by the imaging unit 12 and then performs detection of the direction of the line of sight r20 and identification of a user based on a result of the analysis. In this manner, in the information processing device 1 and the information processing system 500, for the image used to perform the detection of the direction of the line of sight r20 and the identification of a user, the shared imaging unit 12 (for example, an infrared camera) can be used.

In addition, in the information processing device 1 and the information processing system 500 according to the present disclosure, a process relating to analysis of the image is standardized for each of the detection of the direction of the line of sight r20 and the identification of a user. For this reason, the information processing device 1 and the information processing system 500 according to the present disclosure can reduce a processing load in comparison with the case in which the detection of the direction of the line of sight r20 and the identification of a user are separately executed. With the configuration described above, the information processing device 1 and the information processing system 500 according to the present disclosure can realize both of the detection of the direction of the line of sight r20 and the identification of a user with a simpler configuration.

Hereinabove, exemplary embodiments of the present disclosure have been described in detail with reference to the accompanying drawings, however, the technical scope of the present disclosure is not limited thereto. It is obvious that those who have general knowledge in the technical field of the present disclosure can attain various modified examples and altered examples in the range of the technical gist described in the claims, and it is understood that the examples of course belong to the technical scope of the present disclosure.

In addition, the effects described in the present specification are merely illustrative and demonstrative, and not limitative. In other words, the technology according to the present disclosure can exhibit other effects that are evident to those skilled in the art along with or instead of the effects based on the present specification.

Additionally, the present technology may also be configured as below:
(1) An information processing device including:

a line of sight detection unit configured to detect a direction of a line of sight based on an image of an eyeball captured by an imaging unit; and

a user identification unit configured to identify a user based on the image of the eyeball captured by the imaging unit.
(2) The information processing device according to (1),

wherein the line of sight detection unit detects the direction of the line of sight based on images of the eyeball that are sequentially captured, and

wherein the user identification unit identifies a user based on at least one of the images that are sequentially captured.
(3) The information processing device according to (1) or (2), including:

a pupil detection unit configured to detect a pupil from the captured image of the eyeball,

wherein the line of sight detection unit detects the direction of the line of sight based on the position of the pupil detected from the image.
(4) The information processing device according to (3),

wherein the pupil detection unit detects the pupil and an iris from the captured image of the eyeball, and

wherein the user identification unit identifies the user based on the iris detected from the image.
(5) The information processing device according to any one of (1) to (4), including:

a user information acquisition unit configured to acquire user information of the identified user; and

a display control unit configured to cause one or more input fields to be displayed on a screen of a display unit,

wherein the display control unit specifies a selected input field based on the detected direction of the line of sight and position information of each of the one or more input fields on the screen, and

wherein the acquired user information is associated with the specified input field and displayed.
(6) The information processing device according to (5),

wherein the input fields are associated with the types of information to be input into the input fields, and

wherein the display control unit causes information out of the acquired user information which corresponds to the type associated with the selected input field to be associated with the input field and displayed.
(7) The information processing device according to (5) or (6), wherein the display control unit specifies the selected input field based on a region on the screen indicated by the direction of the line of sight and position information of each of the one or more input fields on the screen.
(8) The information processing device according to any one of (5) to (7), wherein, when an instruction which relates to selection of the input field from the user is received, the display control unit specifies the input field indicated by the direction of the line of sight.
(9) The information processing device according to any one of (5) to (8), including the display unit.
(10) The information processing device according to (9), wherein the display unit includes a holding unit configured to hold the display unit on the head of the user so that the display unit is held in front of the eyeball.
(11) The information processing device according to (9) or (10), wherein the display unit is a transmissive-type display device.
(12) The information processing device according to any one of (5) to (8), wherein the display control unit causes the input field to be displayed on a screen of a first display unit, and causes the user information to be displayed as if it were superimposed on the input field in a position on a screen of a second display unit which is different from the first display unit, the position corresponding to a display position of the input field on the screen of the first display unit.
(13) The information processing device according to any one of (1) to (4), including:

a setting information acquisition unit configured to acquire setting information for changing a setting of an application associated with the identified user; and

an application control unit configured to change the setting of the application based on the acquired setting information.
(14) The information processing device according to any one of (1) to (4), including:

an authentication information acquisition unit configured to acquire authentication information for authenticating the identified user; and

an authentication processing unit configured to authenticate the user based on a detection result of the direction of the line of sight and the acquired authentication information.
(15) The information processing device according to any one of (1) to (14), including the imaging unit.
(16) An information processing method including:

causing a processor to detect a direction of a line of sight based on an image of an eyeball captured by an imaging unit; and

causing the processor to identify a user based on the image of the eyeball captured by the imaging unit.

What is claimed is:

1. An information processing device comprising:
a line of sight detection unit configured to detect a direction of a line of sight based on an image of an eyeball captured by an imaging unit; and
a user identification unit configured to identify a user based on the image of the eyeball captured by the imaging unit.

2. The information processing device according to claim 1,
wherein the line of sight detection unit detects the direction of the line of sight based on images of the eyeball that are sequentially captured, and
wherein the user identification unit identifies a user based on at least one of the images that are sequentially captured.

3. The information processing device according to claim 1, comprising:
a pupil detection unit configured to detect a pupil from the captured image of the eyeball,
wherein the line of sight detection unit detects the direction of the line of sight based on the position of the pupil detected from the image.

4. The information processing device according to claim 3,
wherein the pupil detection unit detects the pupil and an iris from the captured image of the eyeball, and
wherein the user identification unit identifies the user based on the iris detected from the image.

5. The information processing device according to claim 1, comprising:
a user information acquisition unit configured to acquire user information of the identified user; and
a display control unit configured to cause one or more input fields to be displayed on a screen of a display unit,
wherein the display control unit specifies a selected input field based on the detected direction of the line of sight and position information of each of the one or more input fields on the screen, and
wherein the acquired user information is associated with the specified input field and displayed.

6. The information processing device according to claim 5,
wherein the input fields are associated with the types of information to be input into the input fields, and
wherein the display control unit causes information out of the acquired user information which corresponds to the type associated with the selected input field to be associated with the input field and displayed.

7. The information processing device according to claim 5, wherein the display control unit specifies the selected input field based on a region on the screen indicated by the direction of the line of sight and position information of each of the one or more input fields on the screen.

8. The information processing device according to claim 5, wherein, when an instruction which relates to selection of the input field from the user is received, the display control unit specifies the input field indicated by the direction of the line of sight.

9. The information processing device according to claim 5, comprising the display unit.

10. The information processing device according to claim 9, wherein the display unit includes a holding unit configured to hold the display unit on the head of the user so that the display unit is held in front of the eyeball.

11. The information processing device according to claim 9, wherein the display unit is a transmissive-type display device.

12. The information processing device according to claim 5, wherein the display control unit causes the input field to be displayed on a screen of a first display unit, and causes the user information to be displayed as if it were superimposed on the input field in a position on a screen of a second display unit which is different from the first display unit, the position corresponding to a display position of the input field on the screen of the first display unit.

13. The information processing device according to claim 1, comprising:
a setting information acquisition unit configured to acquire setting information for changing a setting of an application associated with the identified user; and
an application control unit configured to change the setting of the application based on the acquired setting information.

14. The information processing device according to claim 1, comprising:
an authentication information acquisition unit configured to acquire authentication information for authenticating the identified user; and
an authentication processing unit configured to authenticate the user based on a detection result of the direction of the line of sight and the acquired authentication information.

15. The information processing device according to claim 1, comprising the imaging unit.

16. An information processing method comprising:
causing a processor to detect a direction of a line of sight based on an image of an eyeball captured by an imaging unit; and
causing the processor to identify a user based on the image of the eyeball captured by the imaging unit.
